(19) United States
(12) Patent Application Publication
(10) Pub. No.: US 2017/0019462 A1
(43) Pub. Date: Jan. 19, 2017

(54) MANAGEMENT METHOD AND COMPUTER

(71) Applicant: FUJITSU LIMITED, Kawasaki-shi (JP)

(72) Inventor: Hideki HARA, Yokohama (JP)

(73) Assignee: FUJITSU LIMITED, Kawasaki (JP)

(21) Appl. No.: 15/277,308

(22) Filed: Sep. 27, 2016

Related U.S. Application Data
(63) Continuation of application No. PCT/JP2014/059259, filed on Mar. 28, 2014.

(51) Int. Cl. H04L 29/08; H04L 12/24; H04L 12/26

(52) U.S. Cl. CPC H04L 67/1002; H04L 43/062; H04L 41/0816

(57) ABSTRACT

A plurality of servers are provided by executing server software on a specific computer or other computers in a system. These servers, including first and second servers, have subordinate relationships for propagating load values from one server to another server in the system. The second server is subordinate to the first server. The first server receives a load value from the second server, the received load value representing a load on a group of servers including the second server and its subordinate servers. The first server then determines whether to enhance the system, based on a load value of the first server itself and the load value received from the second server.

### CROSS-REFERENCE TO RELATED APPLICATION

This application is a continuation application of International Application PCT/JP2014/059259 filed on Mar. 28, 2014 which designated the U.S., the entire contents of which are incorporated herein by reference.

### FIELD

The embodiments discussed herein relate to a method for managing load and a computer.

### BACKGROUND

Multiple server devices execute a number of processing operations in parallel according to requests from client devices and the like, thus offering improved efficiency in information processing. The number of server devices in this multi-server system may be optimized depending on its actual load condition. For example, the system allocates more server devices when it experiences a growing load during the operation, so as to reduce the amount of load per server and prevent the system from becoming less efficient. This act of increasing the number of active server devices is called “scale out” in this description.

The procedure of scale out deploys a new server device and configures the system to distribute requests also to that server device. Such scaling operations are initiated by commands from a system administrator or may be automatically performed by the system itself. The latter is called “autoscaling.”

Scaling of a system is initiated on the basis of determination as to whether the system needs enhancement. For example, a management server may be employed to monitor the load condition of the system. When the load per server device exceeds a predetermined threshold, the management server determines to enhance the system by performing a scale-out operation and the like.

There have been proposed various techniques, aside from autoscaling, to deal with increased load on the system. For example, one proposed system optimizes a network that includes a variety of devices configured with different combinations of hardware and software platforms. This system adjusts and optimizes such a network according to the result of accurate evaluation of its performance.

Another proposed technique is about the method of allocating application resources to a cluster of nodes in a non-concentrated manner. According to this method, a local node including a set of active applications receives resource usage data of applications from a node subset. Based on the received resource usage data, the local node modifies the set of applications executed thereon.

Yet another proposed technique provides a computer system that distributes its load across a plurality of servers while maintaining the realtime capabilities of the system in spite of increased load. The proposed technique enables a server to select another server when the former server encounters an excessive load greater than a predetermined upper limit. The selected server is to take over a part of services currently executed in the overloaded server. The computer system then selects one or more services out of the currently assigned services of the overloaded server and reassigns the selected services to the selected server.

See, for example, the following documents:

Japanese National Publication of International Patent Application No. 2005-505859

Japanese Laid-open Patent Publication No. 2007-207225

Japanese Laid-open Patent Publication No. 2010-134518

### SUMMARY

In one aspect of the embodiments, there is provided a non-transitory computer-readable storage medium storing a program. The program causes a computer to perform a procedure including: receiving, as a first server, a load value from at least one second server, the first and second servers being among a plurality of servers provided by executing server software on the computer or other computers in a system, the plurality of servers having subordinate relationships for propagating load values from one server to another server in the system, the second server being subordinate to the first server, the received load value representing a load on a group of servers including the second server and subordinate servers thereof; and determining, as the first server, whether to enhance the system, based on a load value of the first server and the load value received from the second server.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information processing system according to a first embodiment;

FIG. 2 illustrates an information processing system according to a second embodiment;

FIG. 3 is block diagram illustrating an exemplary hardware configuration of an execution server;

FIG. 4 is block diagram illustrating an exemplary tree structure that defines relationships between virtual servers for propagation of performance measurements;

FIG. 5 is block diagram illustrating exemplary connections of virtual servers through which the requests from a terminal device are distributed;

FIG. 6 is block diagram illustrating an example of functions implemented in an execution server and a management server;

FIG. 7 illustrates an example of threshold values defined in a threshold table;

FIG. 8 illustrates an example of a load analysis table;

FIG. 9 illustrates an example of variations of transaction counts;

FIG. 10 illustrates an example of a server count management table;

FIG. 11 is a block diagram illustrating an example of how the number of virtual servers is obtained;

FIG. 12 illustrates an example of a layer management table;

FIG. 13 illustrates an exemplary setup of layer management tables;

FIG. 14 is a flowchart illustrating an exemplary process of autoscaling performed by a virtual server;

FIG. 15 is a flowchart illustrating an exemplary process of obtaining transaction counts;

FIG. 16 is a flowchart illustrating an exemplary process of analyzing transaction counts;

FIG. 17 is a flowchart illustrating an exemplary process of determining and executing autoscaling;

FIG. 18 is a flowchart illustrating an exemplary process of a scale-out operation;

FIG. 19 illustrates an example of how the pertinent devices interact in a scale-out operation;

FIG. 20 is a first block diagram illustrating an example of a scale-out operation;

FIG. 21 is a second block diagram illustrating an example of a scale-out operation;

FIG. 22 is a third block diagram illustrating an example of a scale-out operation;

FIG. 23 is a flowchart illustrating an exemplary process of a first scale-in operation;

FIG. 24 illustrates an example of how the pertinent devices interact in the first scale-in operation;

FIG. 25 is a block diagram illustrating an example of the first scale-in operation;

FIG. 26 is a flowchart illustrating an exemplary process of a second scale-in operation;

FIG. 27 illustrates an example of how the pertinent devices interact in the second scale-in operation;

FIG. 28 is a block diagram illustrating an example of the second scale-in operation;

FIG. 29 is a flowchart illustrating an exemplary process of a third scale-in operation;

FIG. 30 illustrates an example of how the pertinent devices interact in the third scale-in operation;

FIG. 31 is a block diagram illustrating an example of the third scale-in operation;

FIG. 32 illustrates an exemplary variant of a threshold table;

FIG. 33 illustrates an exemplary variant of the load analysis table;

FIG. 34 is a first block diagram for explaining advantages of the second embodiment; and

FIG. 35 is a second block diagram for explaining advantages of the second embodiment.

### DESCRIPTION OF EMBODIMENTS

The conventional system of server devices determines whether to enhance itself depending on variations of the load. One thing to note here is that it may take a non-negligible time from detection of a load variation to determination of system enhancement. For example, a large number of server devices are needed to handle many transactions, meaning that the system as a whole has to spend a long time to monitor and analyze the individual server load. The time for this monitoring and analysis results in an excessive delay of autoscaling before it starts a scale-out procedure. The lack of adequate amounts of processing capacity then manifests itself as a slow response to transaction requests or even causes a system failure.

Several embodiments will be described below with reference to the accompanying drawings.

### (a) First Embodiment

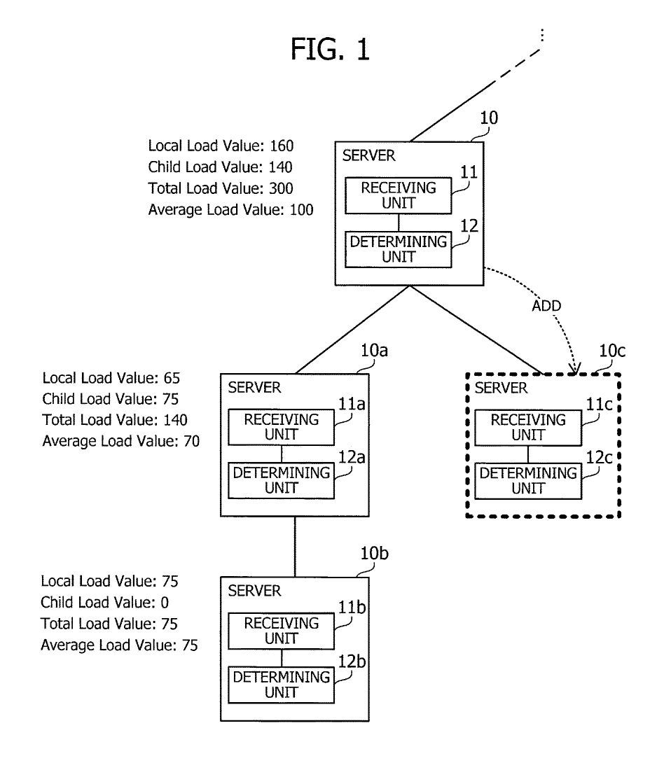

FIG. 1 illustrates an information processing system according to a first embodiment. This information processing system is formed from a plurality of servers 10, 10a, 10b, and 10c, which may be virtual machines. These servers 10, 10a, 10b, and 10c execute a plurality of processes in parallel. The servers 10, 10a, 10b, and 10c pass their load values from one to another according to a tree structure defined for this purpose. That is, each server 10, 10a, 10b, and 10c receives load values from one or more servers located immediately therebelow in the tree structure. For example, one server 10 receives a load value from another server 10a, the load value indicating the load on the latter server 10a and its subordinate server 10b in the tree structure. Then based on their received load values, the individual servers 10, 10a, 10b, and 10c autonomously determine whether to execute autoscaling. Autoscaling is the function of automatically performing a scaling-out or scaling-in operation to enhance or shrink the system according to its load condition. The term “scale out” means increasing the number of servers constituting the system so as to enhance its performance, for example. The term “scale in” means reducing the number of servers constituting the system so as to make more efficient use of resources in the system as a whole. For the determination of autoscaling, the servers 10, 10a, 10b, and 10c are configured to measure their respective load values. The “load value” of a server indicates, for example, the number of transactions executed in a predetermined unit time, or the usage ratio of central processing unit (CPU), or other load indicator of the server.

As seen in FIG. 1, the server 10 includes a receiving unit 11 and a determining unit 12. The receiving unit 11 and determining unit 12 are implemented by using, for example, a processor such as a CPU and digital signal processor (DSP), or other electronic circuits such as an application-specific integrated circuit (ASIC) and field-programmable gate array (FPGA). For example, the processor executes a program stored in a memory. The processor includes arithmetic and logic units and registers for execution of programmed instructions. The processor may further include a dedicated circuit for data processing operations. Similarly to the noted server 10, other servers 10a, 10b, and 10c also have their respective receiving units 11a, 11b, and 11c and determining units 12a, 12b, and 12c.

Specifically, the receiving unit 11 receives a total load value and a total server count from each subordinate server that resides immediately below the server 10 in the tree structure. Total load value of a specific server is the sum of load values with respect to all servers in a subtree of that specific server. Total server count of a specific server is the number of servers that belong to a subtree of that specific server.

The determining unit 12 determines whether to enhance the system, based on the load that the server 10 is experiencing during execution of a plurality of operations, the received total load value, and the received total server count. For example, the determining unit 12 first calculates a total load value of the server 10 and other servers located therebelow in the tree structure by adding together the load value of the server 10 itself and the received total load value. The determining unit 12 also adds one to the received total server count, thereby calculating a new total server count that includes the server 10 and other servers located therebelow in the tree structure. The determining unit 12 subsequently calculates an average of load values on the server 10 and other servers located therebelow by dividing the calculated total load value by the new total server count. The result is referred to as an “average load value.” If this average load value is greater than or equal to a specific threshold, the determining unit 12 determines to enhance the system. For example, this enhancement is accomplished by conducting a scale-out operation. The threshold may be stored in, for example, a volatile memory device such as random access memory (RAM), or in a non-volatile storage device such as hard disk drive (HDD) and flash memory. If the calculated average load value is smaller than another threshold, the determining unit 12 may determine to shrink the system. For example, this shrinkage is accomplished by conducting a scaling-in operation.

The following part of the description will explain a scale-out operation that adds a server 10c to the existing system of servers 10, 10a, and 10b organized in a tree structure. Suppose that the system is configured to start enhancement when a server observes its average load value reaching a threshold of 100. The tree structure places one server 10 at its topmost node as seen in FIG. 1, another server 10a below the server 10, and yet another server 10b below the server 10a. These three servers 10, 10a, and 10b are now referred to as the top server 10, middle server 10a, and bottom server 10b, respectively. In the example of FIG. 1, the top server 10 has its local load value of 160. The middle server 10a has its local load value of 65. The bottom server 10b has its local load value of 75.

Because of the absence of its subordinate servers in the tree structure, the bottom server 10b has a total load value of 75, an average load value of 75, and a total server count of 1. The bottom server 10b thus transmits the total load value “75” and the total server count “1” to the middle server 10a immediately thereabove.

The middle server 10a thus receives a total load value of 75 and a total server count of one from the bottom server 10b. Since the middle server 10a has its local load value of 65, the total load value of the middle server 10a and bottom server 10b amounts to 140. The total server count of the same is 2 (=1+1) since the middle server 10a has received a total server count of one from the bottom server 10b. Accordingly, the average load value of these two servers is calculated to be 70 (=140/2). The middle server 10a transmits its total load value “140” and total server count “2” to the top server 10 immediately thereabove.

The top server 10 thus receives a total load value of 140 and a total server count of 2 from the middle server 10a. Since the top server 10 has its local load value of 160, the total load value of the server 10 and other servers located therebelow in the tree structure amounts to 300. The total server count of the same is 3 (=2+1) since the top server 10 has received a total server count of 2 from the middle server 10a. The average load value of these three servers is calculated to be 100 (=300/3). This average load value equals to the aforementioned threshold (100), the top server 10 outputs a request for a new server 10c, so that another child server will be placed below the top server 10. For example, this request for an additional server may be received by a management server that executes autoscaling. The management server adds a new server 10c to the system, thereby reducing the load on the top server 10.

According to the first embodiment described above, each server receives load values from other servers according to a predefined tree structure. More specifically, each server receives from its immediately subordinate servers in the tree structure a total load value of that subordinate server and other servers located therebelow in the tree structure, as well as a total server count that represents the total number of those servers. Then the individual server autonomously determines whether to enhance the system, on the basis of an average load on that server and other servers therebelow in the tree structure. This method reduces the amount of data that individual servers have to collect for determination of system enhancement, as compared to the case in which one particular server collects load values of a plurality of active servers. The proposed method is able to execute autoscaling without significant delay, because load values of servers can be summarized with less time even when a large number of servers are running.

The servers in the tree structure individually determine whether to perform system enhancement, based on each server's own load value and received total load value. This method enables proper determination even if the servers are experiencing uneven load distribution (e.g., load is concentrated into particular servers). In other words, it is possible to equalize the servers in terms of their load.

The above embodiment uses average load values of individual servers to determine whether to enhance the system. However, the determination does not necessarily rely on these load values alone. Specifically, the determination may also be made depending on how the average load value varies, or even on how such variations vary.

In the above-described embodiment, each server calculates an average load value using a total server count received from other servers immediately therebelow. Alternatively, the total number of servers may be estimated by a server from the depth or height of its corresponding node in the tree structure.

The servers 10, 10a, 10b, and 10c may not necessarily be virtual machines, but may be physical machines. In this case, a scale-out operation may be done by, for example, preparing a plurality of spare servers as a server pool and adding a spare server from the server pool to the system when it is needed. A scale-in operation may be done by returning an active server from the system to the server pool.

### (b) Second Embodiment

The description will now explain a specific example of autoscaling functions implemented in a system of virtual servers. The term “virtualization” refers to the act of abstracting physical resources of a computer. For example, server virtualization permits a single server device to appear as a plurality of server devices. The following description uses the term “virtual servers” to mean such virtualized server devices. In the context of virtualization, “scale out” means increasing the number of virtual servers in the system, and “scale in” means reducing the number of virtual servers in the system.

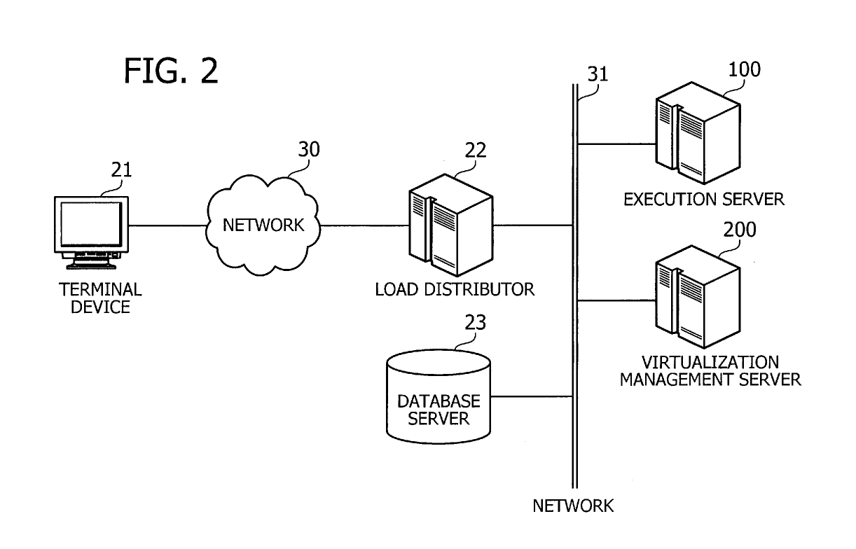

FIG. 2 illustrates an information processing system according to the second embodiment. The illustrated information processing system includes a terminal device 21, a load distributor 22, a database server 23, an execution server 100, and a virtualization management server 200. The terminal device 21 is connected to the load distributor 22 via a network 30. The load distributor 22, database server 23, execution server 100, and virtualization management server 200 are connected to each other via another network 31.

The terminal device 21 is a client computer used by a user of the system. Via the network 30 and load distributor 22, the terminal device 21 requests the execution server 100 to execute a plurality of transactions. The load distributor 22 is a server computer configured to distribute such requested transactions across a plurality of server devices. More specifically, the load distributor 22 receives transaction requests from the terminal device 21 and distributes them across a plurality of virtual servers provided on the execution server 100.

The database server 23 is a server computer configured to record and manage a collection of data in non-volatile storage devices such as HDDs. More specifically, the database server 23 stores data that the execution server 100 may refer to or create when executing transactions.

The execution server 100 is a server computer configured to operate a plurality of virtual servers in parallel. The system may include two or more such execution servers. When that is the case, virtual servers may be distributed across different execution servers. These virtual servers execute transactions requested from the terminal device 21. Depending on the load of transactions, the execution server 100 may send the virtualization management server 200 a scale-out request or scale-in request to add or remove virtual servers.

The virtualization management server 200 is a server computer configured to provide scale-out or scale-in capabilities to the system of virtual servers. More specifically, the virtualization management server 200 scale the virtual servers upon request from the execution server 100 as their owner.

It is noted that the database server 23 and virtualization management server 200 may also be virtualized; that is, they may be virtual machines.

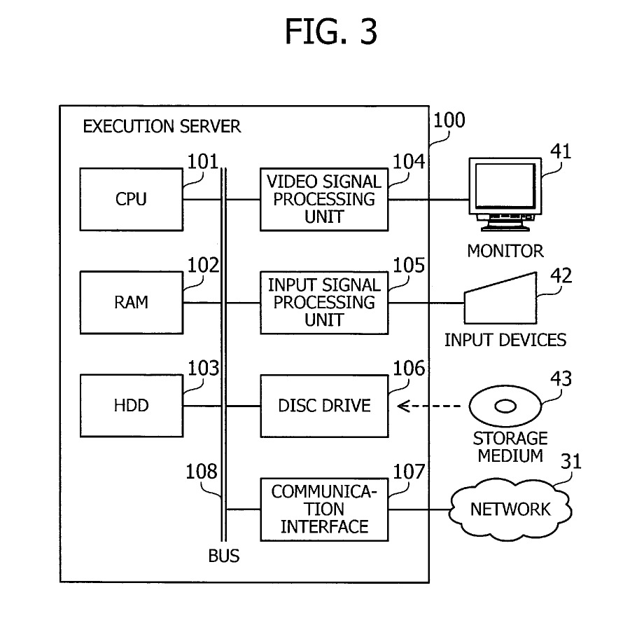

FIG. 3 is block diagram illustrating an exemplary hardware configuration of an execution server. The illustrated execution server 100 includes a CPU 101, a RAM 102, an HDD 103, a video signal processing unit 104, an input signal processing unit 105, a disc drive 106, and a communication interface 107. These elements are connected to a bus 108 in the execution server 100.

The CPU 101 is a processor that contains computation circuits to execute programmed instructions. The CPU 101 reads at least part of program and data files stored in the HDD 103 and executes programs after loading them on the RAM 102. The CPU 101 may include a plurality of processor cores, and the execution server 100 may include two or more such processors. These processors or processor cores may be used to execute multiple processing operations (described later) in parallel.

The RAM 102 is a volatile memory device serving as temporary storage for programs that the CPU 101 executes, as well as for various data that the CPU 101 uses to execute the programs. Other type of memory devices may be used in place of or together with the RAM 102, and the execution server 100 may have two or more sets of such volatile memory devices.

The HDD 103 serves as a non-volatile storage device to store program and data files of the operating system (OS), firmware, applications, and other kinds of software. The execution server 100 may include a plurality of non-volatile storage devices such as flash memories and solid state drives (SSD) in place of, or together with the HDD 103.

The video signal processing unit 104 produces video images in accordance with commands from the CPU 101 and outputs them on a screen of a monitor 41 coupled to the execution server 100. The monitor 41 may be, for example, a cathode ray tube (CRT) display or a liquid crystal display.

The input signal processing unit 105 receives input signals from input devices 42 coupled to the execution server 100 and supplies them to the CPU 101. The input devices 42 may be, for example, a keyboard and a pointing device such as a mouse and touchscreen.

The disc drive 106 is a device used to read programs and data stored in a storage medium 43. The storage medium 43 may include, for example, magnetic disk media such as flexible disk (FD) and HDD, optical disc media such as compact disc (CD) and digital versatile disc (DVD), and magneto-optical storage media such as magneto-optical disc (MO). The disc drive 106 transfers programs and data read out of a storage medium 43 to, for example, the RAM 102 or HDD 103 according to commands from the CPU 101.

The communication interface 107 is an interface for communication with other computers (e.g., load distributor 22 and virtualization management server 200) via a network 31. This communication interface 107 may be a wired link interface for connection to a wired network or a radio link interface for connection to a wireless network.

The execution server 100 may, however, omit the disc drive 106. The video signal processing unit 104 and input signal processing unit 105 may also be omitted in the case where the execution server 100 only works for other computers. While FIG. 3 depicts the execution server 100 alone, the same hardware configuration may similarly be applied to the database server 23 and virtualization management server 200. The terminal device 21 is also implemented by using the illustrated hardware configuration, except that the communication interface 107 has to be connected not to the network 31, but to another network 30 so as to communicate with the load distributor 22, for example. Likewise, the load distributor 22 may also be implemented by using the illustrated hardware configuration, except that the communication interface 107 communicates with other computers (e.g., terminal device 21) via the networks 30 and 31.

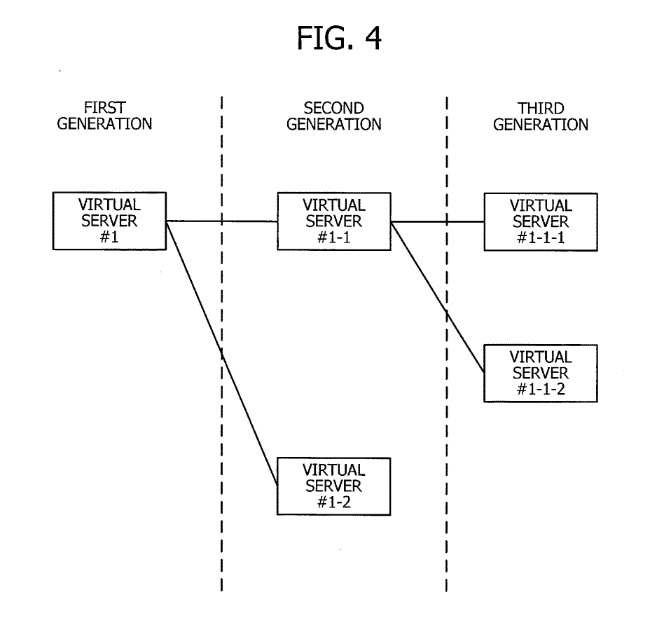

FIG. 4 is block diagram illustrating an exemplary tree structure that defines relationships between virtual servers for propagation of performance measurements. Suppose that five virtual servers #1, #1-1, #1-2, #1-1-1, and #1-1-2 are currently used by the execution server 100. That is, virtual servers #1, #1-1, #1-2, #1-1-1, and #1-1-2 execute a plurality of transactions that the load distributor 22 distributes to them. Each virtual server autonomously determines whether to perform autoscaling of the system.

Virtual servers #1, #1-1, #1-2, #1-1-1, and #1-1-2 are organized in a tree structure. In other words, they are hierarchically structured. According to the second embodiment, the tree structure grows downward from its topmost virtual server #1. Referring to the example of FIG. 4, virtual server #1 has no related virtual server in its upper layer, but is associated with two virtual servers #1-1 and #1-2 in its immediately lower layer. That is, virtual server #1 has no parent virtual server, but two child virtual servers. Virtual server #1-1 has a parent virtual server #1 and two child virtual servers #1-1-1 and #1-1-2. Virtual server #1-2 has a parent virtual server #1, but no child virtual servers. Virtual servers #1-1-1 and #1-1-2 have their parent virtual server #1-1, but no child virtual servers. In this exemplary tree structure, the layer to which the topmost virtual server #1 belongs is called the “first generation.” The layer immediately below the first generation layer is called the “second generation,” to which virtual servers #1-1 and #1-2 belong. The layer immediately below the second generation layer is called the “third generation,” to which virtual servers #1-1-1 and #1-1-2 belong.

The following part of this description will use the wording “a virtual server and its descendants” or the like to refer to a specific subset of virtual servers in their structural tree. That is, this wording refers to the particular virtual server that is mentioned at the beginning and its subordinate virtual servers located in lower layers below the particular virtual server. Those descendants, or subordinate virtual servers, are reached by tracing the structural tree downward from the particular virtual server.

Virtual servers #1, #1-1, #1-2, #1-1-1, and #1-1-2 receive performance measurements from their respective child virtual servers if any. The individual virtual servers #1, #1-1, #1-2, #1-1-1, and #1-1-2 then summarize and analyze the received performance measurements of child servers, together with their own performance measurements. Based on the analyzed performance measurements, each virtual server #1, #1-1, #1-2, #1-1-1, and #1-1-2 determines whether or not to perform a scale-in or scale-out operation.

For example, one virtual server #1-1 receives performance measurements from its child virtual servers #1-1-1 and #1-1-2 and summarizes and analyzed the received performance measurements, together with its own performance measurements. Virtual server #1-1 then transmits the resulting performance measurements to its parent virtual server #1. Virtual server #1-1 also determines whether to request a scale-in or scale-out operation, based on that performance measurements. Similarly, virtual server #1 receives performance measurements from its child virtual servers #1-1 and #1-2 and summarizes and analyzes the received performance measurements, together with its own performance measurements. Then based on the analysis of those performance measurements, virtual server #1 determines whether or not to request a scale-in or scale-out operation.

The virtual servers autonomously manage their autoscaling functions in this way, determining whether to add a new server or remove an existing server, on the basis of performance measurements collected and analyzed with respect to an individual virtual server and its descendants. In other words, the virtual servers own their respective subsets of servers, and each such subset is nested on another such subset. Performance measurements are summarized and analyzed according to this nested structure of server subsets. For example, virtual server #1 summarizes and analyzes performance measurements of five virtual servers #1, #1-1, #1-2, #1-1-1, and #1-1-2. Virtual server #1-1, on the other hand, does the same for three virtual servers #1-1, #1-1-1, and #1-1-2. The latter three virtual servers #1-1, #1-1-1, and #1-1-2 are all included in the servers whose performance measurements are summarizes and analyzed by virtual server #1. This nesting of virtual server groups enables quick detection of a local load variation and prompt determination about autoscaling.

What is seen in FIG. 4 is a tree structure that defines relationships between virtual servers in passing performance measurements. Note that requests from terminal devices are distributed to virtual servers based on different relationships between them.

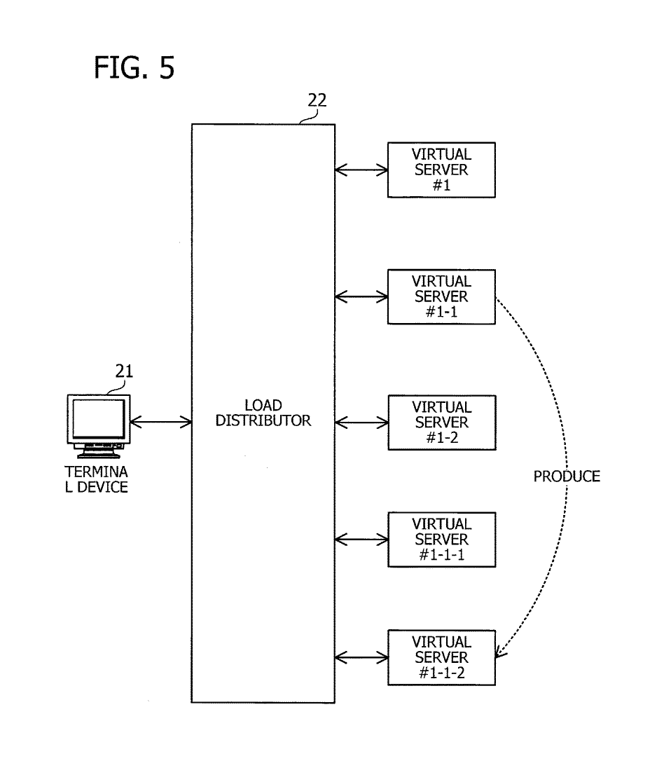

FIG. 5 is block diagram illustrating exemplary connections of virtual servers through which the requests from a terminal device are distributed. The illustrated load distributor 22 receives a plurality of transactions requests from a terminal device 21 and distributes them across virtual servers. If a new virtual server (e.g., virtual server #1-1-2 in FIG. 5) is added for scale out, the load distributor 22 will be able to select destinations of transactions from more virtual servers.

As can be seen from the above, the load distributor 22 distributes transaction requests across virtual servers upon request from the terminal device 21, without considering the foregoing tree structure of those virtual servers.

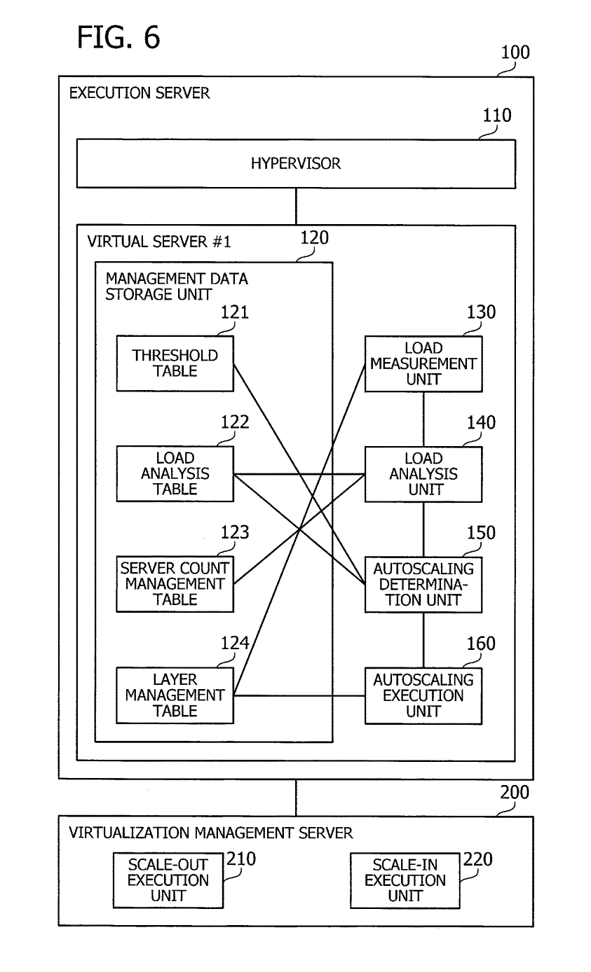

FIG. 6 is block diagram illustrating an example of functions implemented in an execution server and a management server. The illustrated execution server 100 includes a hypervisor 110 and a virtual server #1. The hypervisor 110 is a program that controls the operating system of virtual server #1 to realize its virtualization. The hypervisor 110 allocates resources (e.g., CPU 101, RAM 102, HDD 103) in the execution server 100 to virtual server #1 in an efficient way.

The illustrated virtual server #1 includes a management data storage unit 120, a load measurement unit 130, a load analysis unit 140, an autoscaling determination unit 150, and an autoscaling execution unit 160.

The management data storage unit 120 provides a storage space for some specific information that virtual server #1 manages to perform autoscaling. Specifically, the management data storage unit 120 accommodates a threshold table 121, a load analysis table 122, a server count management table 123, and a layer management table 124. The threshold table 121 stores a collection of thresholds (e.g., the one for average transaction count) used by virtual server #1 to determine whether to perform a scale-out or scale-in operation. These thresholds may be determined by, for example, a system administrator.

The load analysis table 122 is a storage space of average transaction counts and other values obtained as a result of summarization and analysis about the numbers of transactions in virtual server #1 and its descendants. The load analysis table 122 includes multiple records since the analysis is performed at predetermined intervals.

The server count management table 123 stores the number of virtual servers in the parent layer, child layer, and current layer, viewed from the owner of the table (virtual server #1). The server count management table 123 is used to analyze transaction counts. The layer management table 124 stores information that virtual server #1 uses to identify its parent virtual server and child virtual servers.

The load measurement unit 130 measures a transaction count of virtual server #1. The term “transaction count” denotes the number of transactions executed by a virtual server in a predetermined time. The load measurement unit 130 also searches the layer management table 124 for child virtual servers of virtual server #1. The load measurement unit 130 then receives total transaction counts and total virtual server counts at predetermined intervals from each identified child virtual server. The total transaction count of a virtual server means the entire quantity of transactions executed by that virtual server and its descendants in a predetermined time. The total virtual server count of a virtual server means the entire quantity of virtual servers including that virtual server and its descendants.

The load analysis unit 140 calculates a total transaction count of virtual server #1, based on its local transaction count measured by the load measurement unit 130 and its children's total transaction counts received by the load measurement unit 130. The calculated total transaction count is then entered to the load analysis table 122. The load analysis unit 140 also adds up total virtual server counts received by the load measurement unit 130 and enters the resulting sum to the server count management table 123. Then the load analysis unit 140 transmits the calculated total transaction count and total virtual server count to the parent virtual server. Lastly the load analysis unit 140 analyzes information stored in the server count management table 123, together with the calculated total transaction count of virtual server #1, and stores the resulting information into the load analysis table 122. This information includes an average transaction count, i.e., the mean number of transactions that virtual server #1 and its descendants have executed in a predetermined time.

The autoscaling determination unit 150 determines whether to execute a scale-out or scale-in operation for virtual servers, by comparing analysis result values of the load analysis unit 140 with their corresponding thresholds in the threshold table 121. The analysis result values are actually retrieved from the load analysis table 122.

The autoscaling execution unit 160 requests the virtualization management server 200 to execute scaling according to the determination result of the autoscaling determination unit 150. Depending on whether it is scale out or scale in, the autoscaling execution unit 160 updates a relevant record of the layer management table 124.

The virtualization management server 200, on the other hand, includes a scale-out execution unit 210 and a scale-in execution unit 220. The scale-out execution unit 210 adds a new virtual server when a scale-out operation is requested by virtual server #1. The scale-out execution unit 210 then returns a response to virtual server #1 to report completion of the scale-out operation. The scale-in execution unit 220 deletes an existing virtual server when a scale-in operation is requested by virtual server #1. The scale-in execution unit 220 then returns a response to virtual server #1 to report completion of the scale-in operation.

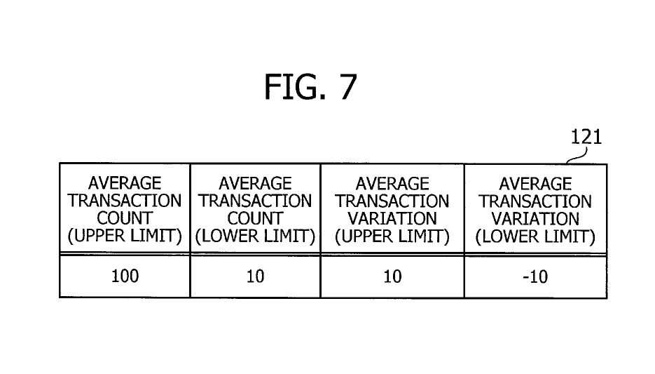

FIG. 7 illustrates an example of threshold values defined in a threshold table. The illustrated threshold table 121 has the following data fields: “average transaction count (upper limit),” “average transaction count (lower limit),” “average transaction variation (upper limit),” and “average transaction variation (lower limit).” The average transaction count (upper limit) field contains an upper limit value for average transaction counts. When the average transaction count of a virtual server reaches or exceeds this upper limit, the virtual server requests a scale-out operation to the virtualization management server 200. The average transaction count (lower limit) field contains a lower limit value for average transaction counts. When the average transaction count of a virtual server falls below this lower limit, the virtual server requests a scale-in operation to the virtualization management server 200. The average transaction variation (upper limit) field contains an upper limit value for average transaction variations. When the average transaction variation of a virtual server reaches or exceeds this upper limit, the virtual server requests a scale-out operation to the virtualization management server 200. The average transaction variation (lower limit) field contains a lower limit value for average transaction variations. When the average transaction variation of a virtual server falls below this lower limit, the virtual server requests a scale-in operation to the virtualization management server 200.

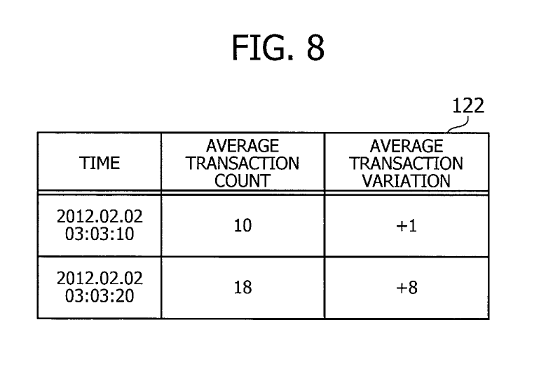

FIG. 8 illustrates an example of a load analysis table. The illustrated load analysis table 122 is formed from the following data fields: “time,” “average transaction count,” and “average transaction variation.” The time field contains a date code and a time code that represent when the values (e.g., average transaction count and variation) associated with this field were calculated. The average transaction count field contains an average transaction count, i.e., the average number of transactions executed by a virtual server per predetermined time. The average transaction variation field indicates a temporal variation of the average transaction count, representing how much the average number of transactions has increased or decreased per predetermined time. More specifically, this average transaction variation is calculated as a difference of the current average transaction count from the previous average transaction count.

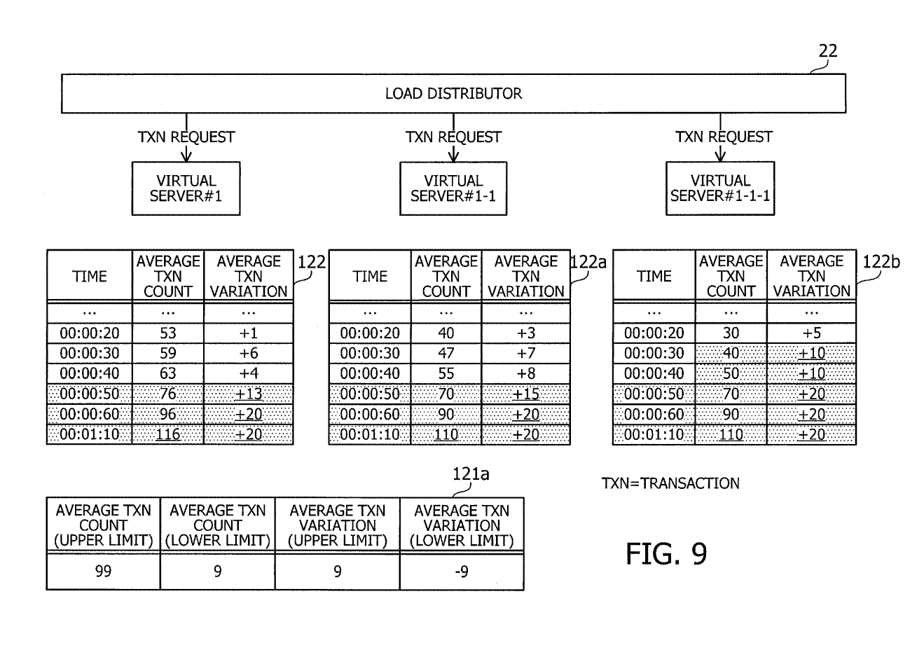

FIG. 9 illustrates an example of variations of transaction counts. Virtual server #1 is a parent of virtual server #1-1, and virtual server #1-1 is a parent of virtual server #1-1-1. These virtual servers #1, #1-1, and #1-1-1 have their respective threshold tables that share the values seen in the threshold table 121a in FIG. 9. That is, the average transaction count (upper limit) is set to 99, and the average transaction count (lower limit) is set to 9. The average transaction variation (upper limit) is set to 9, and the average transaction variation (lower limit) is set to −9.

Three load analysis tables 122, 122a, and 122b are illustrated in FIG. 9, which respectively reside in virtual servers #1, #1-1, and #1-1-1. Note that the time field of these load analysis tables 122, 122a, and 122b omits date codes for simplicity purposes. Each load analysis table 122, 122a, and 122b is updated by its corresponding virtual server every 10 seconds.

The description will now explain an exemplary case in which the load distributor 22 sees a sudden increase of transaction requests from a terminal device 21 (see FIG. 2). Referring first to virtual server #1, the average transaction count grows and reaches its upper threshold (i.e., average transaction count (upper limit) of 99) at the time of 00:01:10. The average transaction variation, on the other hand, reaches the same its upper threshold (i.e., average transaction variation (upper limit) of 9) at the time of 00:00:50, which is earlier than the average transaction count reaches its threshold. Referring next to virtual server #1-1, the average transaction count grows and reaches its upper threshold (i.e., average transaction count (upper limit) of 99) at the time of 00:01:10. The average transaction variation reaches its upper threshold (i.e., average transaction variation (upper limit) of 9) at the time of 00:00:50, which is earlier than the average transaction count reaches its threshold. Referring further to virtual server #1-1-1, the average transaction count grows and reaches its upper threshold (i.e., average transaction count (upper limit) of 99) at the time of 00:01:10. The average transaction variation reaches its upper threshold (i.e., average transaction variation (upper limit) of 9), at the time of 00:00:30, which is earlier than the average transaction count reaches its threshold. Virtual server #1-1-1 reaches the threshold of average transaction variation earlier than other two virtual servers #1 and #1-1.

As can be seen from FIGS. 8 and 9, the proposed virtual servers detect a sign of increasing average transaction counts by analyzing their variations at predetermined intervals. This feature enables prompt determination of a scale-out or scale-in operation for virtual servers when the terminal device 21 exhibits an abrupt change in the number of transactions.

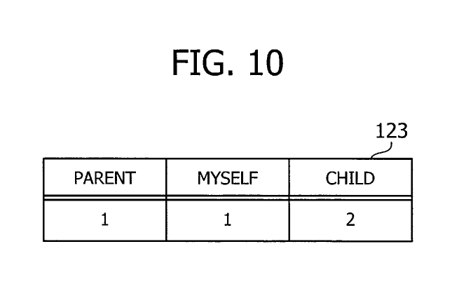

FIG. 10 illustrates an example of a server count management table. The illustrated server count management table 123 is formed from three data fields titled with layer names: “parent,” “myself,” “child.” The parent field contains the number virtual servers located in the layer immediately above the present virtual server (i.e., virtual server #1, or the owner of the table). This number is referred to as a “parent count.” The myself field contains the number of virtual servers belonging to the layer of the present virtual server. This number is referred to as a “myself count.” Actually this data field contains the value of one. The child field indicates the number of virtual servers located in the layer immediately below the present virtual server. This number is referred to as a “child count.”

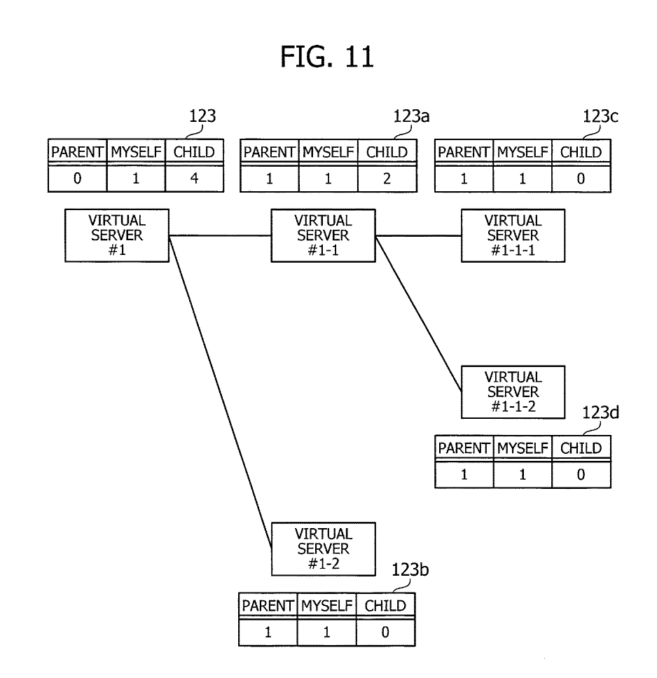

FIG. 11 is a block diagram illustrating an example of how the number of virtual servers is obtained. Each virtual server sends its parent (if present) a child count and a myself count retrieved from its own server count management table. Each virtual server also receives from its children (if present) their respective child counts and myself counts, adds up the received values, and stores the resulting sum into the child field of its own server count management table. This stored child count is transmitted later to the parent virtual server, together with the myself count.

Referring to the example of FIG. 11, virtual server #1 has two child virtual servers #1-1 and #1-2, and virtual server #1-1 has two child virtual servers #1-1-1 and #1-1-2. Each virtual server has its own server count management table. Specifically, virtual server #1 has a server count management table 123. Virtual server #1-1 has a server count management table 123a. Virtual server #1-2 has a server count management table 123b. Virtual server #1-1-1 has a server count management table 123c. Virtual server #1-1-2 has a server count management table 123d.

Virtual servers #1-2, #1-1-1 and #1-1-2 have their respective parents, but no children. Accordingly, the server count management tables 123b, 123c, and 123d contain a value of one in their respective parent fields and a value of zero in their respective child fields. Their respective myself fields contain a value of one.

Virtual server #1-1 receives a child count of zero and a myself count of one from its child virtual server #1-1-1, as well as the same child count and myself count from another child virtual server #1-1-2. Accordingly, the server count management table 123a of virtual server #1-1 gains a child count of two (=0+1+0+1). The server count management table 123a also has a parent count of one and a myself count of one, since virtual server #1-1 has a parent.

Virtual server #1 receives a child count of two and a myself count of one from its child virtual server #1-1. Virtual server #1 also receives a child count of zero and a myself count of one from another child virtual server #1-2. Accordingly, the server count management table 123 of virtual server #1 gains a child count of four (=2+1+0+1). The server count management table 123 also has a parent count of zero and a myself count of one, since virtual server #1 has no parents.

As can be seen from FIGS. 10 and 11, virtual servers are configured to communicate data in their server count management tables with their parents and children. By so doing, the virtual servers manage total virtual server counts of their own.

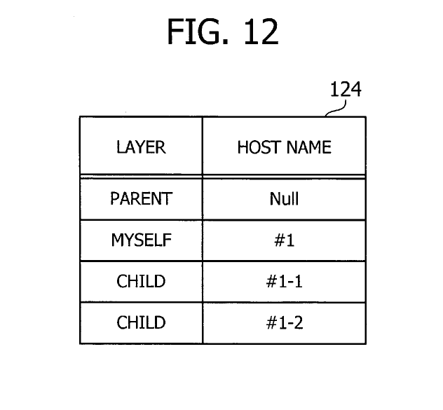

FIG. 12 illustrates an example of a layer management table. This layer management table 124 is formed from the following data fields: “layer” and “host name.” The layer field contains information about relationships between the present virtual server (i.e., the owner of the layer management table 124) and other virtual servers in different layers. More specifically, the layer field contains one of the following layer names: “parent,” “child,” and “myself.” The layer name “parent” means a layer located immediately above the present virtual server. The layer name “child” means a layer located immediate below the present virtual server. The layer name “myself” refers to the layer of the present virtual server. The host name field contains the host name of a virtual server in the corresponding layer. Suppose, for example, that virtual server #1 registers its child virtual server with a host name of “#1-1.” This is achieved by entering a new record with values of “child” and “#1-1” in the layer and host name fields. The following description uses the symbols (e.g., #1, #1-1, . . . ) of virtual servers as their respective host names.

The host name field may contain a value of “Null” to indicate absence of virtual servers in a particular layer. Such null-valued records would be omitted in the following description. As an alternative to the value “Null,” the host name field may be left blank for the layers without virtual servers. As an alternative to host names, the layer management table 124 may have a data field to store an Internet Protocol (IP) address.

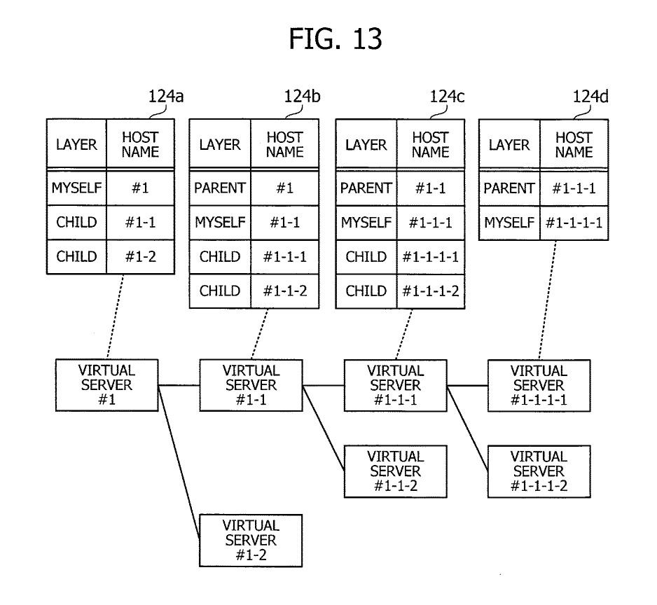

FIG. 13 illustrates an exemplary setup of layer management tables. As seen, virtual server #1 has two child virtual servers #1-1 and #1-2. Virtual server #1-1 has two child virtual servers #1-1-1 and #1-1-2. Virtual server #1-1-1 has two child virtual servers #1-1-1-1 and #1-1-1-2.

In this case, the layer management table 124a of virtual server #1 has three records described below. One record has a layer name of “myself” and a host name of “#1,” and another record has a layer name of “child” and a host name of “#1-1.” Yet another record has a layer name of “child” and a host name of “#1-2.” The layer management table 124b of virtual server #1-1 has four records described below. One record has a layer name of “parent” and a host name of “#1,” and another record has a layer name of “myself” and a host name of “#1-1.” Yet another record has a layer name of “child” and a host name of “#1-1-1,” and still another record has a layer name of “child” and a host name of “#1-1-2.” The layer management table 124c of virtual server #1-1-1 also has four records. That is, one record has a layer name of “parent” and a host name of “#1-1,” and another record has a layer name of “myself” and a host name of “#1-1-1.” Yet another record has a layer name of “child” and a host name of “#1-1-1-1,” and still another record has a layer name of “child” and a host name of “#1-1-1-2.” The layer management table 124d of virtual server #1-1-1-1 has two records. That is, one record has a layer name of “parent” and a host name of “#1-1-1,” and another record has a layer name of “myself” and a host name of “#1-1-1-1.”

As can be seen from FIGS. 12 and 13, the virtual servers individually manage host names of their parent and child virtual servers, in addition to their own host names. This enables the virtual servers to organize themselves in a tree structure.

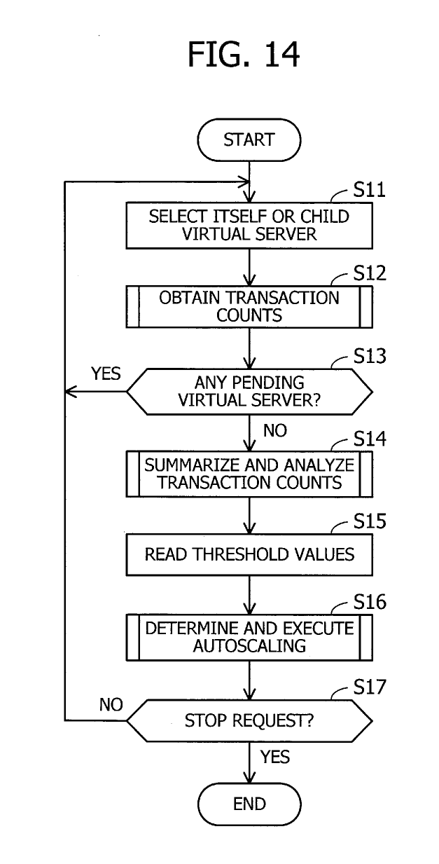

FIG. 14 is a flowchart illustrating an exemplary process of autoscaling performed by a virtual server.

(S11) The load measurement unit 130 selects a virtual server among those having a layer name of “myself” or “child” in the layer management table 124.

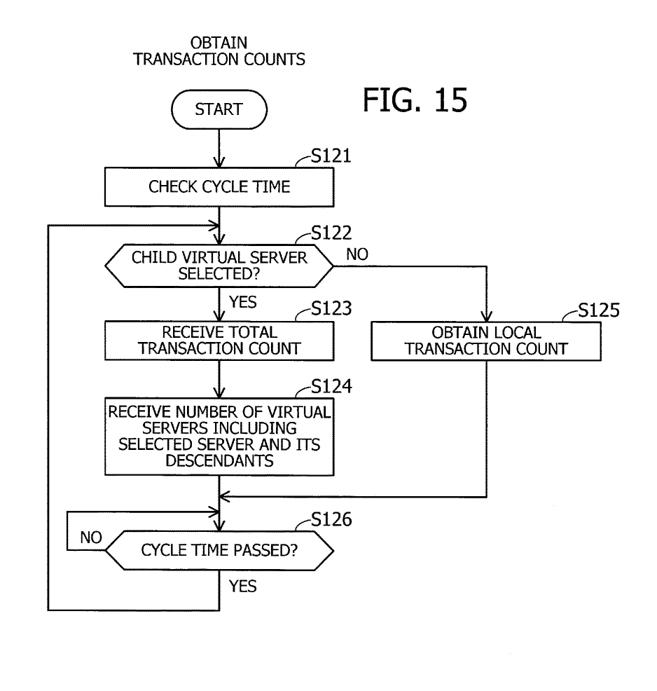

(S12) The load measurement unit 130 obtains performance measurements (e.g., total transaction counts and the like) of the selected virtual server. The details of this operation will be described later with reference to FIG. 15.

(S13) The load measurement unit 130 determines whether any unselected virtual server remains in its own or child layer. If there is such a pending virtual server, the process returns to step S11. If all the relevant virtual servers are done, the process advances to step S14.

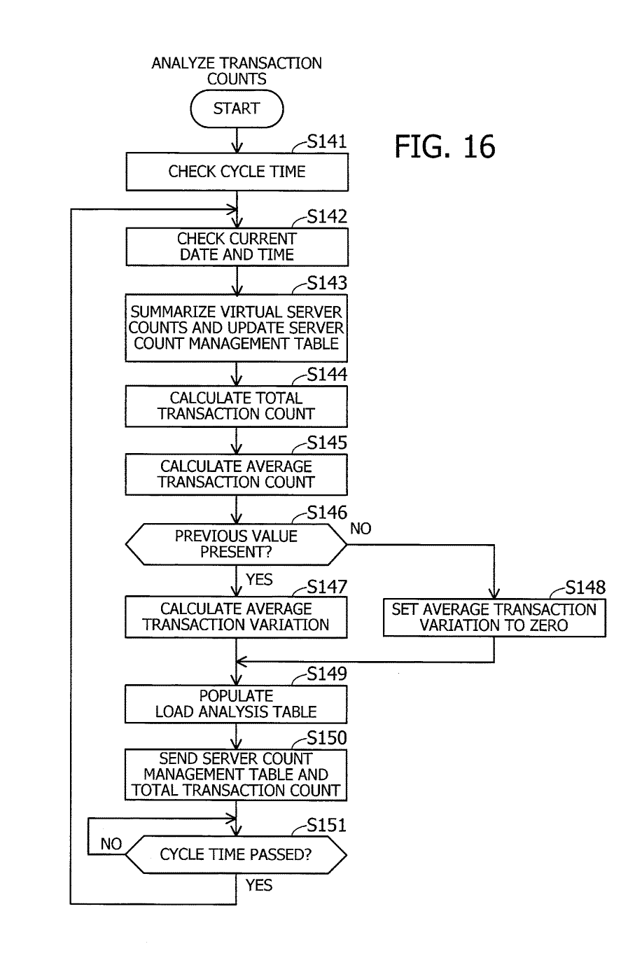

(S14) The load analysis unit 140 summarizes and analyzes total transaction counts and the like obtained in step S12. The details of this operation will be described later with reference to FIG. 16.

(S15) The autoscaling determination unit 150 retrieves threshold values from the threshold table 121.

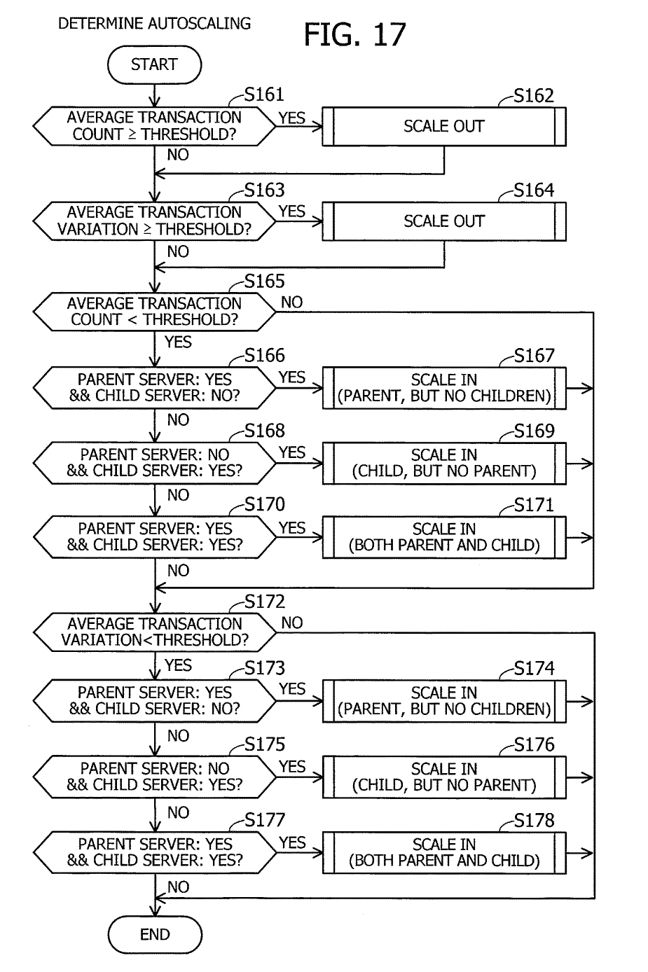

(S16) The autoscaling determination unit 150 determines whether to perform a scale-out or scale-in operation. The autoscaling execution unit 160 scales virtual servers according to the result of this determination. The details of this operation will be described later with reference to FIG. 17.

(S17) The load measurement unit 130 determines whether a stop request has been received. If a stop request has been received, the load measurement unit 130 exits from this process. If not, the process returns to step S11.

FIG. 15 is a flowchart illustrating an exemplary process of obtaining transaction counts. This process is called up in step S12 of FIG. 14.

(S121) The load measurement unit 130 checks “cycle time,” which represents time intervals at which virtual server #1 measures or analyzes performance measurements such as transaction counts. For example, this cycle time may be a setup parameter defined by an administrator of the system, or may be initialized with some appropriate value before the administrator gives a specific value. The cycle time may be set to a default value in case that no explicit setup is made by an administrator. Whatever method is used for setup, the cycle time value is recorded in an appropriate storage space in virtual server #1.

(S122) The load measurement unit 130 determines whether the virtual server selected in step S11 is a child virtual server. If it is a child virtual server, the process advances to step S123. If not, the process proceeds to step S125.

(S123) The load measurement unit 130 communicates with the selected child virtual server to receive its total transaction count. This total transaction count represents the total number of transactions executed by the sending virtual server and its descendants during the most recent cycle time obtained in step S121.

(S124) The load measurement unit 130 communicates with the selected child virtual server to receive its total virtual server count. This total virtual server count of a virtual server represents the total number of virtual servers including that server itself and all of its descendants. In the present case, the selected child virtual server is included as one of those virtual servers.

(S125) This step S125 is taken when the present virtual server has selected itself. The load measurement unit 130 then obtains the transaction count of the present virtual server. This transaction count represents the number of transactions executed by the present virtual server during the most recent cycle time obtained in step S121.

(S126) The load measurement unit 130 determines whether the cycle time obtained in step S121 has passed. When the cycle time has passed, the process returns to step S122. Otherwise, the process repeats step S126.

FIG. 16 is a flowchart illustrating an exemplary process of analyzing transaction counts. This process is called up in step S14 of FIG. 14.

(S141) The load analysis unit 140 checks the cycle time as in step S121.

(S142) The load analysis unit 140 checks the current date and time.

(S143) The load analysis unit 140 adds up the number of child virtual servers and the total virtual server counts obtained from those child virtual servers in step S12 of FIG. 14, thus outputting a summarized number of virtual server counts. The load analysis unit 140 updates the child field of its local server count management table 123 with this summarized number of virtual server counts.

(S144) The load analysis unit 140 adds up the transaction counts obtained in step S12 of FIG. 14, thus calculating a total transaction count of the present virtual server.

(S145) Based on the total transaction count and summarized number of virtual server counts obtained above, the load analysis unit 140 calculates an average transaction count of the present virtual server. More specifically, this is achieved by dividing the total transaction count by the number of child virtual servers plus one. Note that the number of child virtual servers is retrieved from the server count management table 123, and the addend of one refers to the present virtual server.

(S146) The load analysis unit 140 determines whether the load analysis table 122 has a previous value of average transaction count. If it has, the process advances to step S147. Otherwise, the process proceeds to step S148.

(S147) The load analysis unit 140 calculates an average transaction variation by subtracting the previous average transaction count from the current average transaction count of step S145.

(S148) The load analysis unit 140 sets zero as an initial value of average transaction variation.

(S149) The load analysis unit 140 populates the load analysis table 122 with a new record formed from the values obtained above. That is, the current date and time checked in step S142 is set to the time field, and the average transaction count calculated in step S145 is entered to the average transaction count field. The average transaction variation calculated in step S147 or initialized in step S148 is given to the average transaction variation field.

(S150) The load analysis unit 140 sends the parent virtual server the calculated total transaction count, together with the number of child virtual servers (i.e., the child field of the server count management table 123) and its own virtual server count (i.e., the myself field of the server count management table 123).

(S151) The load analysis unit 140 determines whether the cycle time obtained in step S141 has passed. When the cycle time has passed, the process returns to step S142. Otherwise, the process repeats step S151.

As can be seen from FIGS. 15 and 16, virtual servers are configured to summarize and analyze transaction counts of themselves and their descendants at predetermined cycle times. Note here that each virtual server summarizes and analyzes transaction counts asynchronously with summarization or analysis of child virtual servers. In other words, it is possible to eliminate the time for synchronizing with summarization or analysis of child virtual servers, thus accelerating autoscaling.

FIG. 17 is a flowchart illustrating an exemplary process of determining and executing autoscaling. This process is called up in step S16 of FIG. 14.

(S161) The autoscaling determination unit 150 checks whether the average transaction count registered in step S149 has reached a threshold. Specifically, the average transaction count (upper limit) in the threshold table 121 is used as the threshold in this step. When the average transaction count is equal to or greater than this threshold, the process proceeds to step S162. Otherwise, the process advances to step S163.

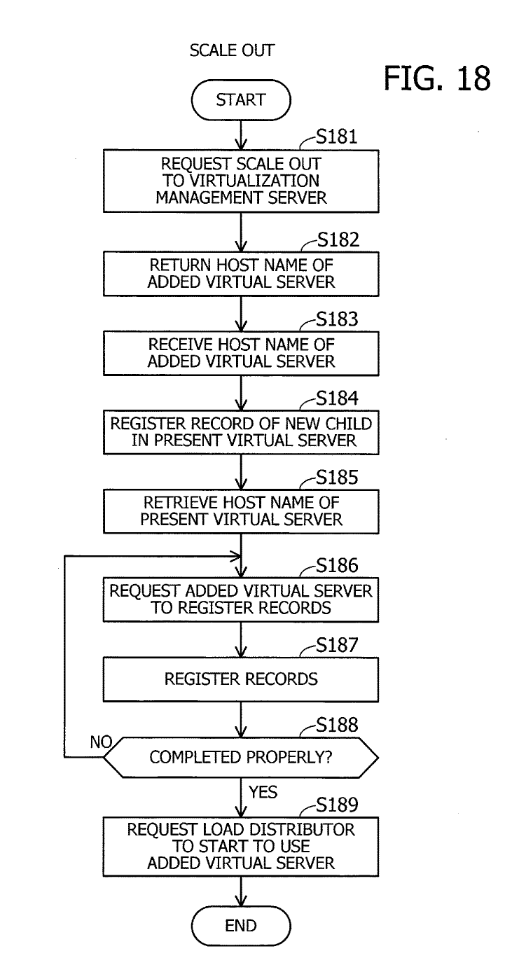

(S162) The autoscaling execution unit 160 executes a scale-out operation. The details of this operation will be described later with reference to FIG. 18.

(S163) The autoscaling determination unit 150 checks whether the average transaction variation registered in step S149 has reached a threshold. Specifically, the average transaction variation (upper limit) in the threshold table 121 is used as the threshold in this step. When the average transaction variation is equal to or greater than this threshold, the process proceeds to step S164. Otherwise, the process advances to step S165.

(S164) The autoscaling execution unit 160 executes a scale-out operation. The details of this operation will be described later with reference to FIG. 18.

(S165) The autoscaling determination unit 150 checks whether the average transaction count registered in step S149 has fallen below a threshold. Specifically, the average transaction count (lower limit) in the threshold table 121 is used as the threshold in this step. When the average transaction count is smaller than this threshold, the process goes to step S166. Otherwise, the process skips to step S172.

(S166) The autoscaling determination unit 150 examines the layer management table 124 to determine whether the present virtual server has a parent but no children. Specifically, if the layer management table 124 contains a record with a layer name of “parent,” then it means that the present virtual server has a parent. If the layer management table 124 contains a record with a layer name of “child,” then it means that the present virtual server has a child. (These tests also apply to later steps). When the present virtual server has a parent, but no children, the process proceeds to step S167. When the present virtual server does not have a parent, or when it has a child or children, the process advances to step S168.

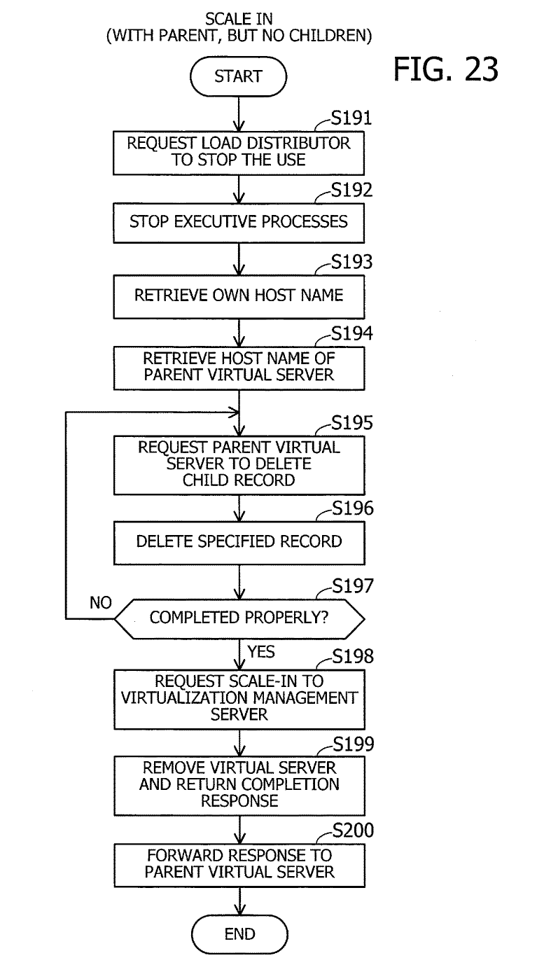

(S167) The autoscaling execution unit 160 executes a scale-in operation for the case in which the present virtual server has a parent, but no children. The details of this operation will be described later with reference to FIG. 23.

(S168) The autoscaling determination unit 150 examines the layer management table 124 to determine whether the present virtual server has a child, but no parent. When the present virtual server has a child or children, but does not have a parent, the process proceeds to step S169. When the present virtual server has a parent, or when it has no children, the process advances to step S170.

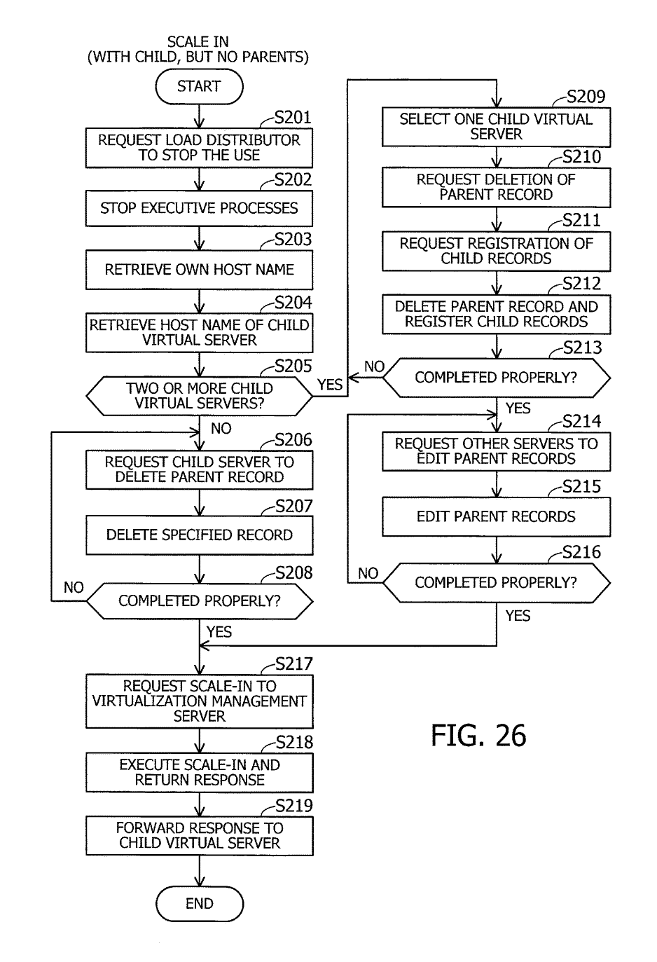

(S169) The autoscaling execution unit 160 executes a scale-in operation for the case in which the present virtual server has a child, but no parent. The details of this operation will be described later with reference to FIG. 26.

(S170) The autoscaling determination unit 150 examines the layer management table 124 to determine whether the present virtual server has both a parent and child. When the present virtual server has both a parent and child, the process proceeds to step S171. When the present virtual server has no parents, or when it has no children, the process advances to step S172.

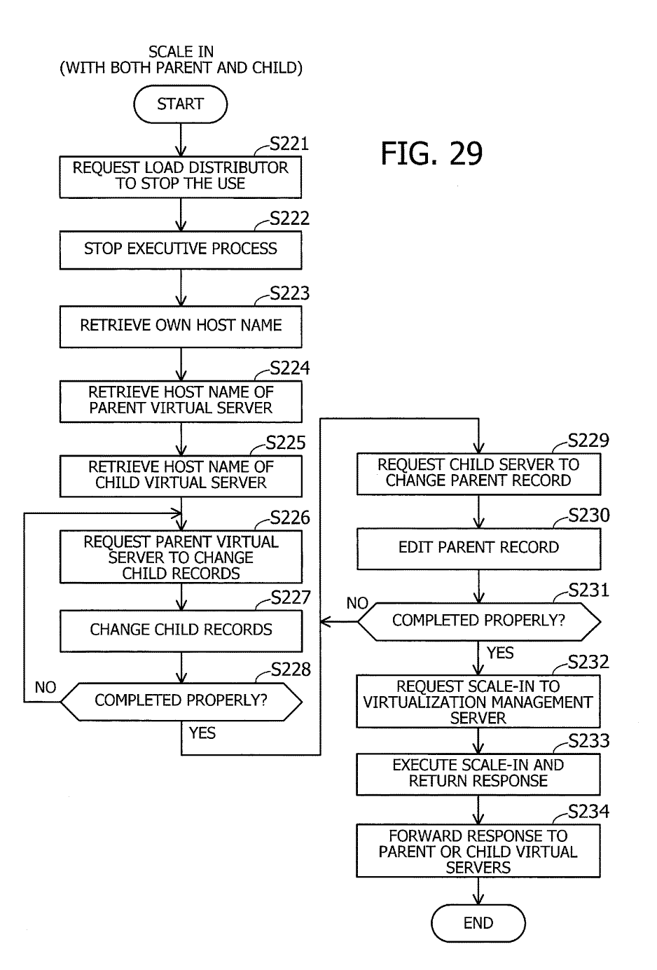

(S171) The autoscaling execution unit 160 executes a scale-in operation for the case in which the present virtual server has both a parent and child. The details of this operation will be described later with reference to FIG. 29.

(S172) The autoscaling determination unit 150 determines whether load analysis table 122 exhibits a drop of average transaction variation below a threshold. Specifically, the average transaction variation (lower limit) in the threshold table 121 is used as the threshold in this step. When the average transaction variation has dropped below this threshold, the process advances to step S173. When the average transaction variation is equal to or greater than this threshold, the autoscaling determination unit 150 exits from the present process.

(S173) The autoscaling determination unit 150 examines the layer management table 124 to determine whether the present virtual server has a parent, but no children. When the present virtual server has a parent, but no children, the process proceeds to step S174. When the present virtual server has no parents, or when it has a child, the process advances to step S175.

(S174) The autoscaling execution unit 160 executes a scale-in operation for the case in which the present virtual server has a parent, but no children. The details of this operation will be described later with reference to FIG. 23.

(S175) The autoscaling determination unit 150 examines the layer management table 124 to determine whether the present virtual server has a child, but no parent. When the present virtual server has a child or children, but does not have a parent, the process proceeds to step S176. When the present virtual server has a parent, or when it has no children, the process advances to step S177.

(S176) The autoscaling execution unit 160 executes a scale-in operation for the case in which the present virtual server has a child, but no parent. The details of this operation will be described later with reference to FIG. 26.

(S177) The autoscaling determination unit 150 examines the layer management table 124 to determine whether the present virtual server has both a parent and child. When the present virtual server has both a parent and child, the process proceeds to step S178. When the present virtual server has no parents, or when it has no children, the autoscaling determination unit 150 exits from the present process.

(S178) The autoscaling execution unit 160 executes a scale-in operation for the case in which the present virtual server has both a parent and child. The details of this operation will be described later with reference to FIG. 29.

The description now turns to the details of a scale-out operation. FIG. 18 is a flowchart illustrating an exemplary process of a scale-out operation. This process is called up in steps S162 and S164 of FIG. 17.

(S181) The autoscaling execution unit 160 in virtual server #1 requests the virtualization management server 200 to perform a scale-out operation for virtual servers.

(S182) The scale-out execution unit 210 in the virtualization management server 200 receives the request from virtual server #1 and carries out a scale-out operation. The scale-out execution unit 210 then returns the host name (or IP address) of the added virtual server as a response to the requesting virtual server #1.

(S183) The autoscaling execution unit 160 learns the host name of the added virtual server from the response of the virtualization management server 200.

(S184) The autoscaling execution unit 160 registers a record of the added virtual server in the layer management table 124 by combining the host name of step S183 with a layer name of “child.”

(S185) The autoscaling execution unit 160 retrieves the host name of the present virtual server. More specifically, the autoscaling execution unit 160 searches the layer management table 124 for a record having a layer name of “myself” and extracts the host name from that record.

(S186) The autoscaling execution unit 160 requests the added virtual server to register records in its layer management table. More specifically, the scale-out execution unit 210 requests registration of two records. One record is to have a layer name of “myself” and the host name received in step S183. The other record is to have a layer name of “parent” and the host name retrieved in step S185.

(S187) The added virtual server registers the records detailed above in its own layer management table and returns a response to virtual server #1 to report the registration result.

(S188) The autoscaling execution unit 160 examines the response from the added virtual server to determine whether it indicates a proper completion. When the response indicates a proper completion, the process advances to step S189. Otherwise, the process returns to step S186.

(S189) The autoscaling execution unit 160 requests the load distributor 22 to start to use the added virtual server. The load distributor 22 then returns a response to the request.

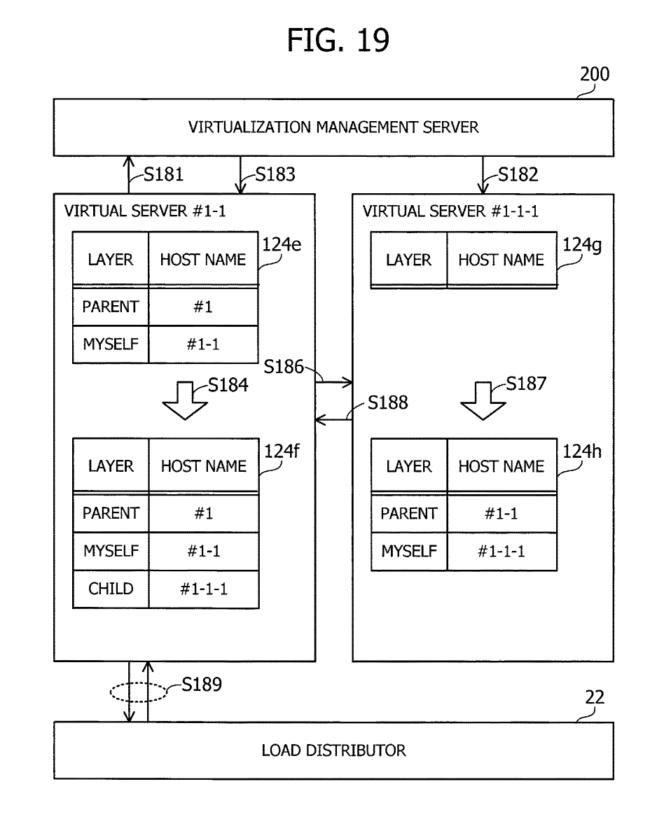

FIG. 19 illustrates an example of how the pertinent devices interact in a scale-out operation. This example of FIG. 19 assumes that one virtual server #1-1 is ready to request a scale-out operation.

Virtual server #1-1 initiates scale out by sending a scale-out request to the virtualization management server 200 to add a virtual server (step S181). The virtualization management server 200 receives this request from virtual server #1-1 and executes a scale-out operation to add its new child virtual server #1-1-1 (step S182). The requesting virtual server #1-1 receives a response from the virtualization management server 200, which contains the host name “#1-1-1” of the added virtual server #1-1-1 (step S183).

Virtual server #1-1 updates its layer management table 124e by registering a new record containing the received host name “#1-1-1” with a layer name of “child” (step S184). FIG. 19 depicts a layer management table 124f representing the state after the registration of a new record.

Virtual server #1-1 searches its layer management table 124f for a record having a layer name of “myself” and extracts a host name “#1-1” from that record. Virtual server #1-1 then requests its new child virtual server #1-1-1 to register two records in its layer management table 124g, one record containing a layer name of “parent” and the extracted host name “#1-1” and the other record containing a layer name of “myself” and the received host name “#1-1-1” (step S186). Upon receipt of this request from virtual server #1-1, the child virtual server #1-1-1 registers these two records in its own layer management table 124g (step S187). FIG. 19 depicts a layer management table 124h representing the state after the registration of new records. Virtual server #1-1-1 returns a response to virtual server #1-1 to report the result of the registration (step S188). Virtual server #1-1 requests the load distributor 22 to start to use virtual server #1-1-1 and receives a response from the load distributor 22 (step S189).

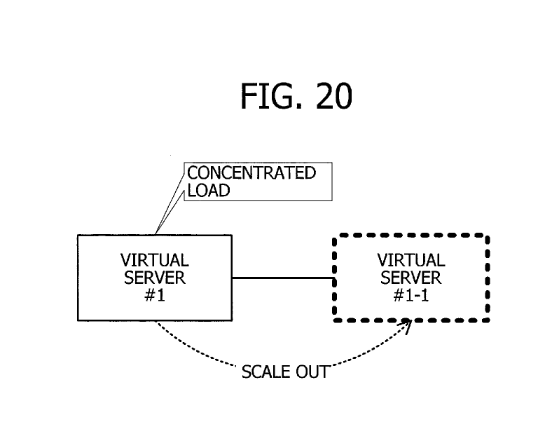

FIG. 20 is a first block diagram illustrating an example of a scale-out operation. Initially one virtual server #1 sits alone in the system of FIG. 20. This virtual server #1 outputs a scale-out request, and another virtual server #1-1 is added accordingly as a child of virtual server #1.

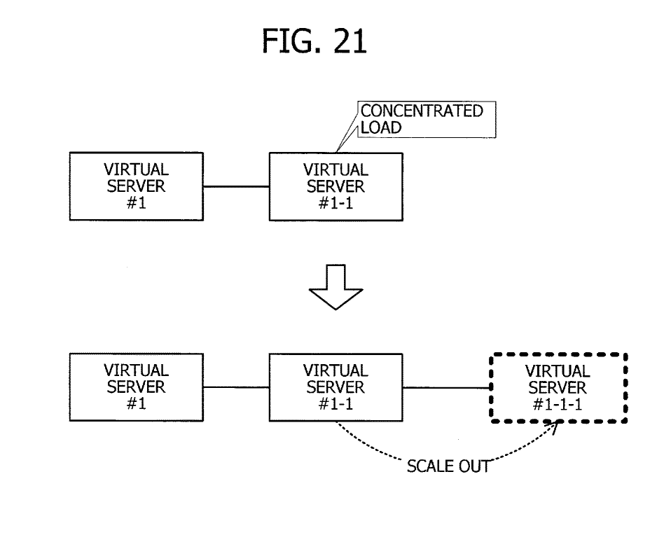

FIG. 21 is a second block diagram illustrating an example of a scale-out operation. The illustrated system includes virtual server #1 and its child virtual server #1-1. The latter virtual server #1-1 outputs a scale-out request, and another virtual server #1-1-1 is added as a child of virtual server #1-1.

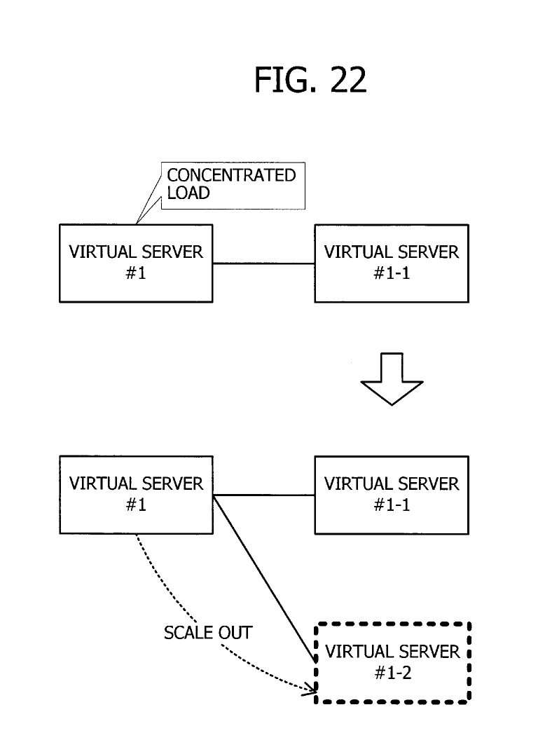

FIG. 22 is a third block diagram illustrating an example of a scale-out operation. The illustrated system includes virtual server #1 and its child virtual server #1-1. The former virtual server #1 outputs a scale-out request, and another virtual server #1-2 is added as the second child of virtual server #1.

As can be seen from FIGS. 18 to 22, in a scale-out procedure, the requesting virtual server enters a new record to its respective layer management table. This record registers the added virtual server as a child virtual server of the requesting virtual server.

The description now turns to a first scale-in operation executed in the case where the requesting virtual server has a parent, but no children. FIG. 23 is a flowchart illustrating an exemplary process of this first scale-in operation. Actually the process of FIG. 23 is called up in steps S167 and S174 of FIG. 17.

(S191) The autoscaling execution unit 160 requests the load distributor 22 to stop the use of the present virtual server. The load distributor 22 then returns a response to this request.

(S192) The autoscaling execution unit 160 stops active processes executing transactions after all active transactions are finished.

(S193) The autoscaling execution unit 160 retrieves the host name of the present virtual server. More specifically, the autoscaling execution unit 160 searches the layer management table 124 for a record having a layer name of “myself” and extracts the host name from that record.

(S194) The autoscaling execution unit 160 retrieves the host name of the parent virtual server. More specifically, the autoscaling execution unit 160 searches the layer management table 124 for a record having a layer name of “parent” and extracts the host name from that record.

(S195) The autoscaling execution unit 160 requests the parent virtual server to delete one existing record that contains a layer name of “child” and the host name retrieved in step S193.

(S196) Upon receipt of the request, the parent virtual server deletes the specified record from its layer management table. The parent virtual server then returns a response to virtual server #1 to report the result of the above record deletion.

(S197) The autoscaling execution unit 160 receives the response from the parent virtual server and determines whether the response indicates a proper completion. When it indicates a proper completion, the process advances to step S198. Otherwise, the process returns to step S195.

(S198) The autoscaling execution unit 160 requests the virtualization management server 200 to perform a scale-in operation to remove the present virtual server (i.e., virtual server #1).

(S199) Upon receipt of the above request, the scale-in execution unit 220 carries out a scale-in operation for virtual server #1. The scale-in execution unit 220 then returns a response to virtual server #1 to report completion of the scale-in operation.

(S200) The autoscaling execution unit 160 forwards the response indicating completion from the virtualization management server 200 to the parent virtual server.

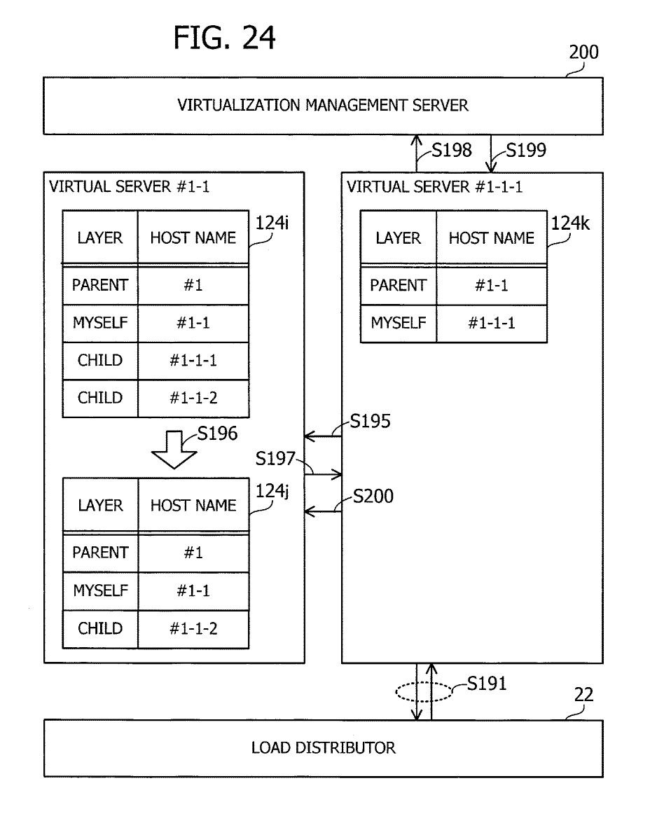

FIG. 24 illustrates an example of how the pertinent devices interact in the first scale-in operation. This example of FIG. 24 assumes that one virtual server #1-1-1 is requesting a scale-in operation. The illustrated system includes virtual server #1-1 and its child virtual server #1-1-1. Virtual server #1-1-1 has no child virtual servers.

Virtual server #1-1-1 first requests the load distributor 22 to stop the use of virtual server #1-1-1 itself and receives a response from the load distributor 22 (step S191). Virtual server #1-1-1 searches its layer management table 124k for records having a layer name of “myself” or “parent” and extracts a host name from each found record. Virtual server #1-1-1 then requests the parent virtual server #1-1 to delete an existing record from its layer management table 124i, the record containing the host name “#1-1-1” extracted from the record of “myself” (step S195). Virtual server #1-1 edits its layer management table 124i to delete a record having a layer name of “child” and a host name of “#1-1-1” (step S196). FIG. 24 illustrates a layer management table 124j representing the state after the deletion of a child record. Virtual server #1-1 returns a response to virtual server #1-1-1 to report the result of the record deletion. Virtual server #1-1-1 receives this response from virtual server #1-1 (step S197).

Virtual server #1-1-1 requests the virtualization management server 200 to perform a scale-in operation to remove virtual server #1-1-1 itself (step S198). The virtualization management server 200 receives this request from virtual server #1-1-1 and executes a scale-in operation to remove virtual server #1-1-1. The virtualization management server 200 then returns a response to virtual server #1-1-1 to report completion of the scale-in operation (step S199). Virtual server #1-1-1 transmits this response to its parent virtual server #1-1 (step S200).

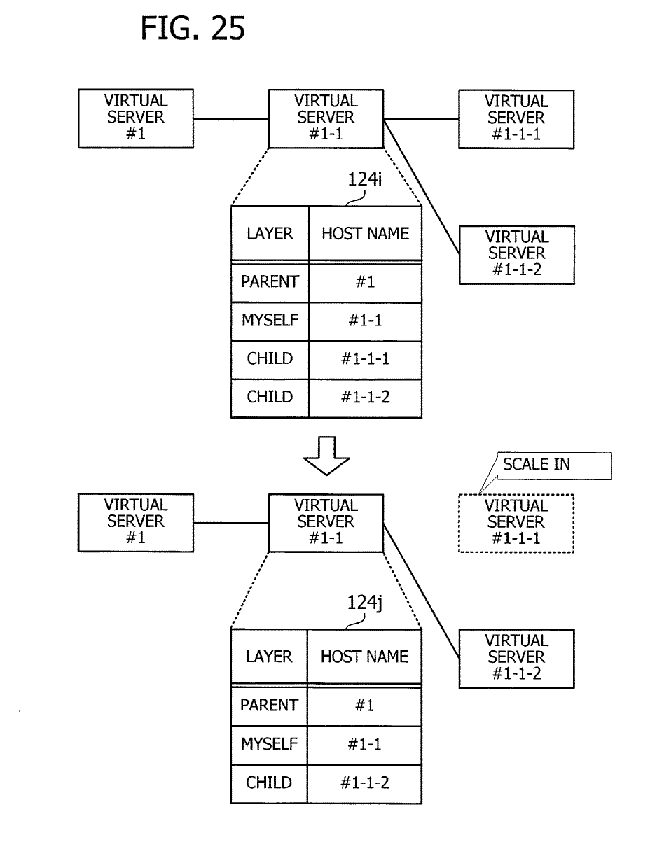

FIG. 25 is a block diagram illustrating an example of the first scale-in operation. The illustrated tree structure includes a virtual server #1 and its child virtual server #1-1. Further, virtual server #1-1 has two child virtual servers #1-1-1 and #1-1-2. Suppose now that virtual server #1-1-1 requests a scale-in operation. The parent virtual server #1-1 then deletes a record with a host name of “#1-1-1” from its layer management table 124i. The lower half of FIG. 25 illustrates a layer management table 124j representing the state after this record deletion. In the resulting structure of virtual servers, virtual server #1 still has a child virtual server #1-1, and virtual server #1-1 has a child virtual server #1-1-2.

Having a parent but no children means being located at leaf nodes of the structural tree. When such a leaf-node virtual server requests a scale-in operation, the parent virtual server edits its layer management table to delete a record of the removed server. The remaining virtual servers maintain their tree structure even after the leaf-node virtual server is deleted.

The description now turns to a second scale-in operation executed in the case where the requesting virtual server has a child but no parent. FIG. 26 is a flowchart illustrating an exemplary process of this second scale-in operation. Actually the process of FIG. 26 is called up in steps S169 and S176 of FIG. 17.

(S201) The autoscaling execution unit 160 requests the load distributor 22 to stop the use of the present virtual server (i.e., virtual server #1). The load distributor 22 then returns a response to this request.

(S202) The autoscaling execution unit 160 stops active processes executing transactions after all active transactions are finished.

(S203) The autoscaling execution unit 160 retrieves the host name of the present virtual server. More specifically, the autoscaling execution unit 160 searches the layer management table 124 for a record having a layer name of “myself” and extracts the host name from that record.

(S204) The autoscaling execution unit 160 retrieves host names of child virtual servers. More specifically, the autoscaling execution unit 160 searches the layer management table 124 for one or more records having a layer name of “child” and extracts the host name from each found record.

(S205) The autoscaling execution unit 160 determines whether the present virtual server has a plurality of child virtual servers or a single child virtual server. In the case of two or more child virtual servers, the process branches to step S209. In the case of a single child virtual server, the process advances to step S206.

(S206) The autoscaling execution unit 160 requests the parent virtual server identified in step S203 to delete an existing record that contains a layer name of “child” and the host name retrieved in step S204.

(S207) Upon receipt of the request, the parent virtual server deletes the specified record from its layer management table. The parent virtual server then returns a response to virtual server #1 to report the result of the above record deletion.

(S208) The autoscaling execution unit 160 examines the received response to determine whether it indicates a proper completion. When the response indicates a proper completion, the process advances to step S217. Otherwise, the process returns to step S206.

(S209) The autoscaling execution unit 160 selects one of the child virtual servers that are found in step S204.

(S210) The autoscaling execution unit 160 requests the selected child virtual server to delete an existing record that contains a layer name of “parent” and the host name retrieved in step S203.

(S211) The autoscaling execution unit 160 requests the selected child virtual server to register records with a layer name of “child” and each host name retrieved in step S204 other than that of the selected child virtual server.

(S212) Upon receipt of the requests issued in steps S210 and S211, the selected child virtual server deletes a record that contains a layer name of “parent” and the host name retrieved in step S203 and registers records with a layer name of “child” and each host name retrieved in step S204 other than that of the selected child virtual server. The selected child virtual server then returns a response to virtual server #1 to report the result of the above record deletion and registration.

(S213) The autoscaling execution unit 160 receives the response from the selected child virtual server and determines whether the response indicates a proper completion. When the response indicates a proper completion, the process advances to step S214. Otherwise, the process returns to step S209.

(S214) The autoscaling execution unit 160 requests the remaining (i.e., non-selected) child virtual servers to change the host name of their parent registered in their respective layer management tables to the host name selected in step S209.

(S215) Upon receipt of the request, the child virtual servers edit their respective layer management tables by changing the host name field of the record with a layer name of “parent” to the host name selected in step S209. Each of those child virtual servers then returns a response to virtual server #1 to report the result of this update.

(S216) The autoscaling execution unit 160 examines each response to determine whether it indicates a proper completion. When each response indicates a proper completion, the process advances to step S217. Otherwise, the process returns to step S214.

(S217) The autoscaling execution unit 160 requests the virtualization management server 200 to perform a scale-in operation to remove the present virtual server itself (i.e., virtual server #1).

(S218) Upon receipt of the scale-in request, the scale-in execution unit 220 carries out a scale-in operation to remove virtual server #1. The scale-in execution unit 220 then returns a response to virtual server #1 to report completion of the scale-in operation.

(S219) The autoscaling execution unit 160 forwards the response indicating completion from the virtualization management server 200 to the child virtual servers.

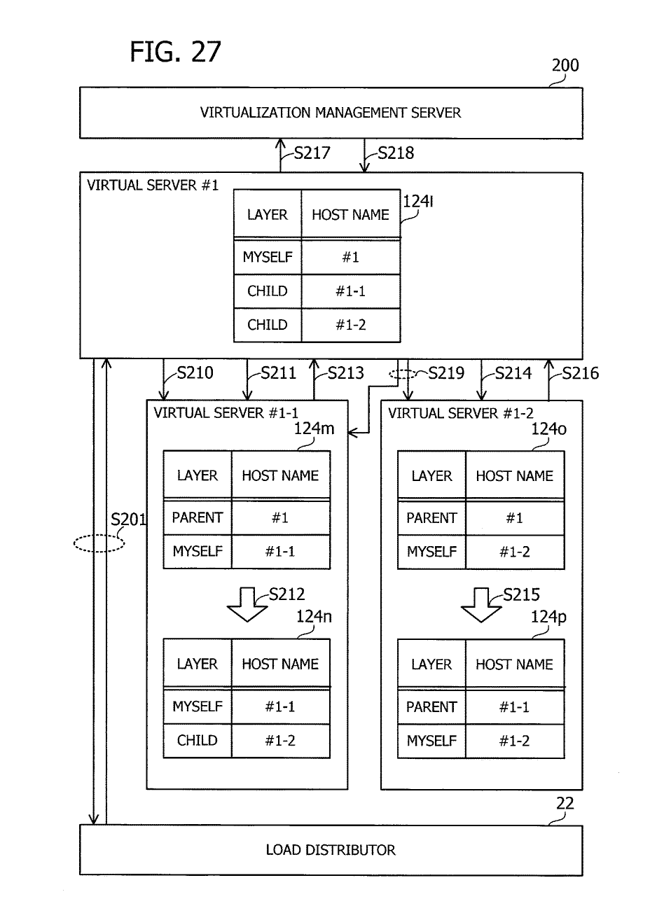

FIG. 27 illustrates an example of how the pertinent devices interact in the second scale-in operation. This example assumes that virtual server #1 is requesting a scale-in operation. The illustrated system includes virtual server #1 and its child virtual servers #1-1 and #1-2. Virtual server #1 has no parent virtual server.

Virtual server #1 first requests the load distributor 22 to stop the use of virtual server #1 and receives a response from the load distributor 22 (step S201). Virtual server #1 searches its layer management table 124l for a record having a layer name of “myself” and extracts a host name of “#1” from that record. Using the same layer management table 124l, virtual server #1 also seeks records having a layer name of “child” and extracts host names “#1-1” and “#1-2” from the found records. Virtual server #1 then selects one of the found host names of its children. Suppose here that “#1-1” is selected.

Virtual server #1 requests the selected virtual server #1-1 to edit its layer management table 124m so as to delete an existing record that contains a layer name of “parent” and the host name “#1” of virtual server #1 (step S210). Virtual server #1 also requests the selected virtual server #1-1 to register a record with a layer name of “child” and the host name “#1-2” of the other child virtual server in the layer management table 124m (step S211).

Upon receipt of the above requests, virtual server #1-1 edits its layer management table 124m by deleting a record with a layer name of “parent” and a host name of “#1” and registering a record with a layer name of “child” and a host name of “#1-2” (step S212). FIG. 27 depicts a layer management table 124n representing the state after the deletion of a parent record and registration of a child record. Virtual server #1-1 then returns a response to virtual server #1 to report the result (step S213).

Virtual server #1 requests the non-selected virtual server #1-2 to edit its layer management table 124o so as to change the host name of an existing record with a layer name of “parent” to the host name “#1-1” of the selected virtual server (step S214). The layer management table 124o in virtual server #1-2 contains a host name of “#1” as part of its parent record. Virtual server #1-2 thus changes that host name to “#1-1” (step S215). FIG. 27 depicts a layer management table 124p representing the state after the change of host names. Virtual server #1-2 then returns a response to virtual server #1 to report the result of the change (step S216).

Virtual server #1 now requests the virtualization management server 200 to perform a scale-in operation to remove virtual server #1 itself (step S217). The virtualization management server 200 receives this request and executes a scale-in operation to remove virtual server #1. The virtualization management server 200 then returns a response to virtual server #1 to report completion of the scale-in operation (step S218). Virtual server #1 transmits this response of the virtualization management server 200 to its former child virtual servers #1-1 and #1-2 (step S219).

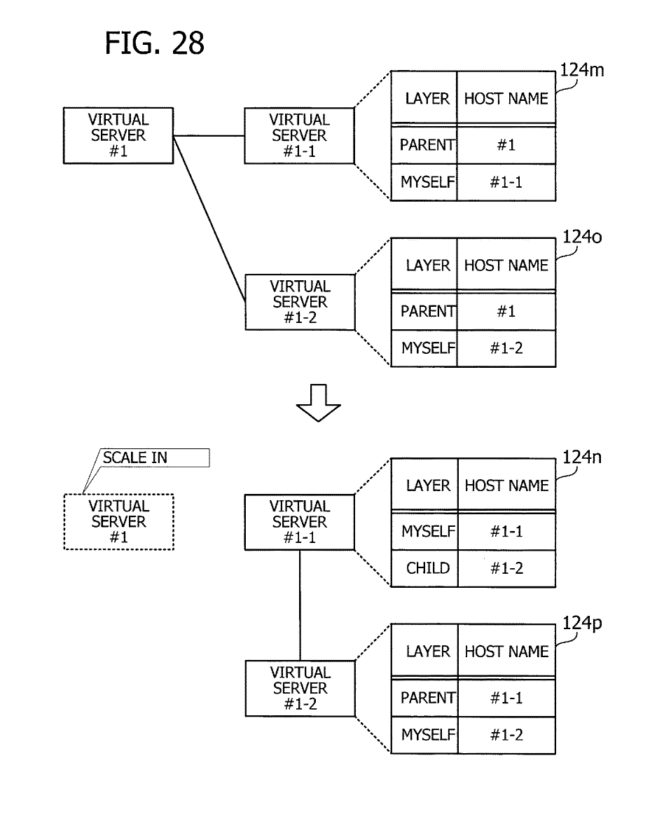

FIG. 28 is a block diagram illustrating an example of the second scale-in operation. The illustrated tree structure includes a virtual server #1 and its child virtual servers #1-1 and #1-2. Suppose now that virtual server #1 requests a scale-in operation to remove itself. Virtual server #1-1 is then selected as a new parent and thus deletes a record with a layer name of “parent” from its layer management table 124m. Virtual server #1-1 further registers a new record containing a layer name of “child” and a host name of “#1-2.” The lower half of FIG. 28 depicts a layer management table 124n representing the state after these changes. Virtual server #1-2 has a host name of “#1” as part of its parent record in the layer management table 124o. Virtual server #1-2 changes that host name to the host name “#1-1” of the selected virtual server. The lower half of FIG. 28 depicts a layer management table 124p representing the state after the change of host names.

Having children but no parents means being located at the root of the structural tree. When a scale-in operation is requested to remove such a root-node virtual server, its child virtual servers modify their respective layer management tables. Specifically, one of those child virtual servers deletes its parent record and registers a child record so as to place itself as a new root node in the tree structure. The remaining child virtual servers update their respective parent records so as to make the new root-node virtual server be their new parent. In other words, the structural tree is reformed in such a way that the root node is moved to one of the child virtual servers of the virtual server to be removed and the remaining child virtual servers become children of the new root-node virtual server. In this way, the virtual servers are still organized in a tree structure even after scale out.

The description now turns to a third scale-in operation executed in the case where the requesting virtual server has both a parent and child. FIG. 29 is a flowchart illustrating an exemplary process of this third scale-in operation. This process is called up in steps S171 and S178 of FIG. 17.

(S221) The autoscaling execution unit 160 requests the load distributor 22 to stop the use of the present virtual server (i.e., virtual server #1). The load distributor 22 then returns a response to this request.

(S222) The autoscaling execution unit 160 stops active processes executing transactions in virtual server #1 after all active transactions are finished.

(S223) The autoscaling execution unit 160 retrieves the host name of the present virtual server. More specifically, the autoscaling execution unit 160 searches the layer management table 124 for a record having a layer name of “myself” and extracts the host name from that record.

(S224) The autoscaling execution unit 160 retrieves the host name of the parent virtual server. More specifically, the autoscaling execution unit 160 searches the layer management table 124 for a record having a layer name of “parent” and extracts the host name from that record.

(S225) The autoscaling execution unit 160 retrieves a host name of a child virtual server. More specifically, the autoscaling execution unit 160 searches the layer management table 124 for one or more records having a layer name of “child” and extracts the host name from each found record.

(S226) The autoscaling execution unit 160 requests the parent virtual server to delete an existing child record from its layer management table. Specifically, this existing record contains a layer name of “child” and the host name retrieved in step S223. The autoscaling execution unit 160 further requests the parent virtual server to register a new record in its layer management table. This new record will have a layer name of “child” and the host name retrieved in step S225. Actually the autoscaling execution unit 160 requests registration of as many records as the number of relevant child virtual servers.

(S227) Upon receipt of the request, the parent virtual server edits its layer management table by deleting an existing child record that contains the host name retrieved in step S223 and instead registering a new child record(s) that contains the host name(s) retrieved in step S225. The parent virtual server then returns a response to virtual server #1 to report the result of the above record deletion and registration.

(S228) The autoscaling execution unit 160 receives the response from the parent virtual server and determines whether the response indicates a proper completion. When the response indicates a proper completion, the process advances to step S229. Otherwise, the process returns to step S226.

(S229) The autoscaling execution unit 160 requests each child virtual server to edit its layer management table so as to change the host name field of a record having a layer name of “parent” and the host name retrieved in step S223 to the host name retrieved in step S224.

(S230) Upon receipt of the request, each child virtual server edits its layer management table to change the host name field of the specified parent record to the host name retrieved in step S224. Each child virtual server then returns a response to virtual server #1 to report the result of this record editing.

(S231) The autoscaling execution unit 160 receives a response from each child virtual server and determines whether the response indicates a proper completion. When the response indicates a proper completion, the process advances to step S232. Otherwise, the process returns to step S229.

(S232) The autoscaling execution unit 160 requests the virtualization management server 200 to perform a scale-in operation to remove the present virtual server #1.

(S233) Upon receipt of the scale-in request, the scale-in execution unit 220 carries out a scale-in operation to remove virtual server #1. The scale-in execution unit 220 then returns a response to virtual server #1 to report completion of the scale-in operation.

(S234) The autoscaling execution unit 160 forwards the response indicating completion of scale-in from the virtualization management server 200 to the parent virtual server or child virtual servers.

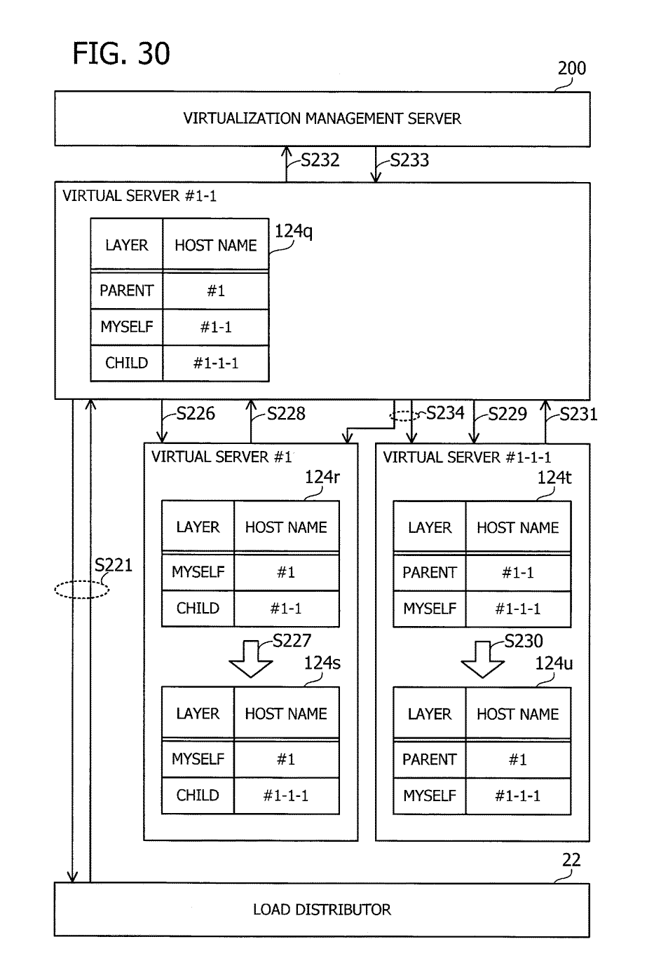

FIG. 30 illustrates an example of how the pertinent devices interact in the third scale-in operation. This example of FIG. 30 assumes that one virtual server #1-1 is requesting a scale-in operation, and that the requesting virtual server #1-1 has both a parent virtual server #1 and a child virtual server #1-1-1.

Virtual server #1-1 first requests the load distributor 22 to stop the use of virtual server #1-1 and receives a response from the load distributor 22 (step S221). Virtual server #1-1 searches its layer management table 124q for a record with a layer name of “myself” and extracts the host name “#1-1” from that record. Virtual server #1-1 also seeks a record with a layer name of “parent” in the layer management table 124q and extracts the host name “#1” from that record. Virtual server #1-1 further finds a record with a layer name of “child” in the layer management table 124q and extracts a host name “#1-1-1” from that record.

Virtual server #1-1 now requests the parent virtual server to change a child record in its layer management table 124r. Specifically, this request is to delete an existing record having a layer name of “child” and the host name “#1-1” of the virtual server to be removed, and to register a record with a layer name of “child” and the host name “#1-1-1” of the child virtual server found above (step S226).

Upon receipt of the above request, virtual server #1 deletes an existing record having a layer name of “child” and the host name “#1-1” from its layer management table 124r. Virtual server #1 registers a new record with a layer name of “child” and the host name “#1-1-1” of the child virtual server (step S227). FIG. 30 depicts a layer management table 124s representing the state after these changes. Virtual server #1 then returns a response to virtual server #1-1 to report the result of the changes (step S228).

Virtual server #1-1 then requests its child virtual server #1-1-1 to edit its layer management table 124t so as to change the host name field of a record having a layer name of “parent” to the host name “#1” representing the parent of virtual server #1-1 (step S229). In response, virtual server #1-1-1 edits its layer management table 124t and changes the host name “#1-1” in its parent record to “#1” (step S230). FIG. 30 depicts a layer management table 124u representing the state after the change of host names. Virtual server #1-1-1 then returns a response to virtual server #1-1 to report the result of the change (step S231).

Virtual server #1-1 now requests the virtualization management server 200 to perform a scale-in operation to remove virtual server #1-1 itself (step S232). The virtualization management server 200 receives this request from virtual server #1-1 and executes a scale-in operation to remove virtual server #1-1. The virtualization management server 200 then returns a response to virtual server #1-1 to report completion of the scale-in operation (step S233). Virtual server #1-1 transmits this response to its parent virtual server #1 and child virtual server #1-1-1 to report the execution of a scale-in operation (step S234).

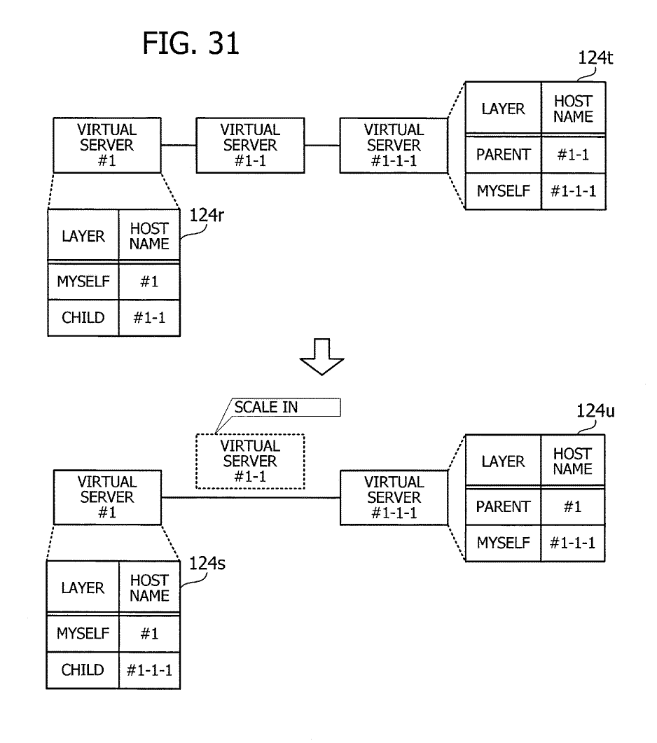

FIG. 31 is a block diagram illustrating an example of the third scale-in operation. The illustrated tree structure includes a virtual server #1 and its child virtual server #1-1. Further, virtual server #1-1 has its child virtual server #1-1-1. Suppose now that virtual server #1-1 requests a scale-in operation to remove itself. In response, virtual server #1 edits its layer management table 124r by deleting an existing child record and registering a new child record with a host name of “#1-1-1” that represents the child of virtual server #1-1. The lower half of FIG. 31 depicts a layer management table 124s representing the state after the record deletion and registration. Virtual server #1-1-1, on the other hand, changes the host name of its parent record in the layer management table 124t to the host name “#1” representing the parent of virtual server #1-1. The lower half of FIG. 31 depicts a layer management table 124u representing the state after this change of host names.

Having both a parent and child means being located between the root node and leaf nodes of the structural tree. When such a virtual server requests a scale-in operation, its parent virtual server edits its layer management table so as to become a parent of child virtual servers immediately below the virtual server to be removed. This editing moves the parent virtual server to a layer immediately above the child virtual servers. The edited tree structure is maintained by the remaining virtual servers after the scale-in operation is finished.

The description will now discuss a variant of the second embodiment. According to this variant, virtual servers make a decision about scale-out or scale-in operations on the basis not only of average transaction count and average transaction variation, but also of variations of the average transaction variation.

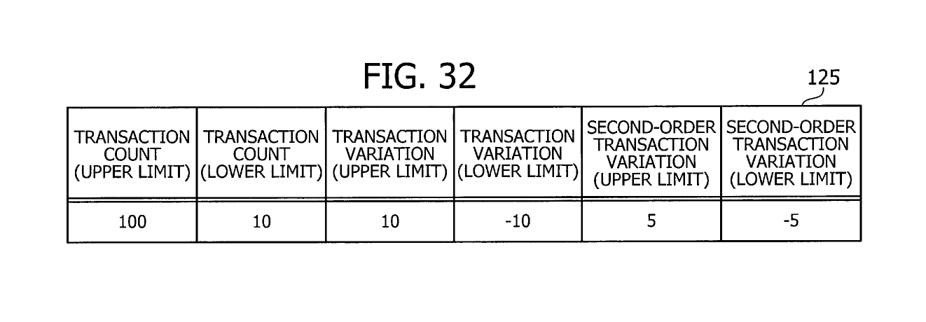

FIG. 32 illustrates an exemplary variant of a threshold table. The illustrated threshold table 125 is a variant of the foregoing threshold table 121. This threshold table 125 is formed from the following data fields: “transaction count (upper limit),” “transaction count (lower limit),” “transaction variation (upper limit),” “transaction variation (lower limit),” “second-order transaction variation (upper limit),” and “second-order transaction variation (lower limit).” See the previous description of the threshold table 121 for details of the transaction count (upper limit) field, transaction count (lower limit) field, transaction variation (upper limit) field, and transaction variation (lower limit) field. The second-order transaction variation (upper limit) field contains an upper limit value for variations of the average transaction variation. Specifically, when the average transaction variation of a virtual server exhibits a variation equal to or greater than this upper limit, the virtual server requests a scale-out operation to the virtualization management server 200. The second-order transaction variation (lower limit) field contains a lower limit value for variations of the average transaction variation. When the average transaction variation of a virtual server exhibits a negative variation that is below this lower limit, the virtual server requests a scale-in operation to the virtualization management server 200.

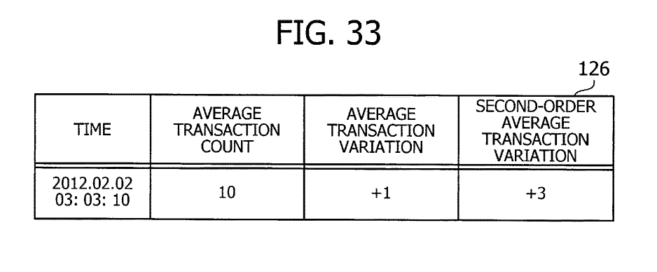

FIG. 33 illustrates an exemplary variant of the load analysis table. The illustrated load analysis table 126 is formed from the following data fields: “time,” “average transaction count,” “average transaction variation,” and “second-order average transaction variation.” See the previous description of the load analysis table 122 for details of the time field, average transaction count field, and average transaction variation field. The second-order average transaction variation field contains the amount of variations per predetermined cycle time in the average transaction variation observed by a virtual server. In other words, the second-order average transaction variation denotes a variation of variation in the average transaction count. Specifically, a second-order average transaction variation is calculated as a difference of the current average transaction variation from the previous average transaction variation.

As can be seen from FIGS. 32 and 33, the variation of the second embodiment examines the second-order variation (i.e., variation of variation) of the average transaction counts, in addition to the average transaction count and average transaction variation discussed in the second embodiment, to determine whether to execute a scale-out or scale-in operation. The use of the second-order variation makes it possible to detect a sign of an abrupt change in the transaction count and quickly take countermeasures such as a scale-out operation.

The second embodiment has been described above. According to the second embodiment, a plurality of virtual servers execute multiple transactions in parallel. These virtual servers form a tree structure, and performance measurements, such as average transaction counts, of servers are transported from lower layer to upper layer of the tree structure. Specifically, each virtual server receives performance measurements from its child virtual servers located immediately therebelow. This method distributes the communication traffic of performance measurements across multiple servers, in contrast to the case in which one dedicated server collects the same from a plurality of transaction-processing servers. It is thus possible to summarize performance measurements without significant delays and quickly make scaling decisions even if the system includes a large number of virtual servers.

Other performance measurements for determination of scaling include average transaction variations, and variations of the same. The use of these values makes it possible to predict an abrupt change in the transaction counts and scale the system promptly when transaction requests from the terminal device 21 exhibit such a change.

Each virtual server keeps track of the average number of transactions executed in itself and its descendants in the tree structure for determining whether to scale. This distributive approach equalizes the performance measurements across virtual servers, as opposed to the case in which the average number of transactions of all virtual servers in the system is monitored at a single server.

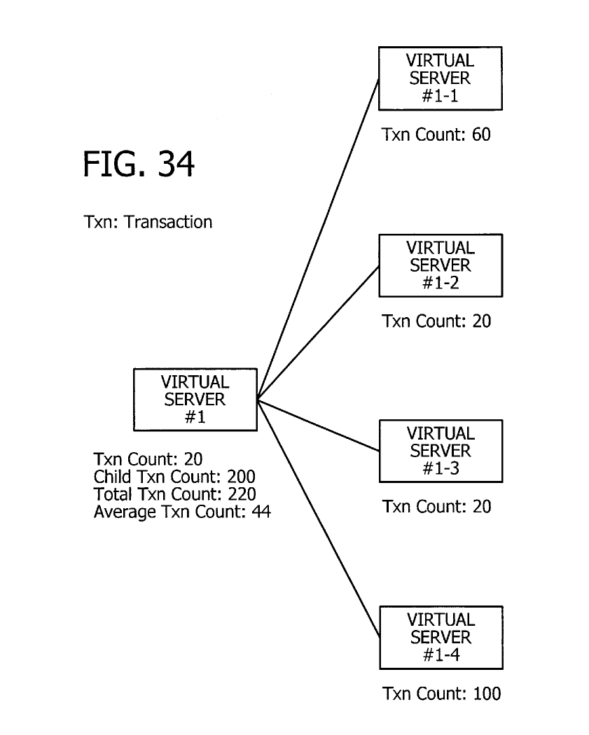

FIG. 34 is a first block diagram for explaining advantages of the second embodiment. This block diagram of FIG. 34 actually explains management of autoscaling without the method proposed in the second embodiment. Virtual servers #1, #1-1, #1-2, #1-3, and #1-4 are used as execution servers for transactions. These virtual servers #1, #1-1, #1-2, #1-3, and #1-4 execute transactions in parallel as requested by terminal devices. Virtual server #1 is connected to virtual server #1-1, #1-2, #1-3, and #1-4 and receives transaction counts from them. Virtual server #1 calculates an average transaction count of all virtual servers on the basis of the received transaction counts and its own transaction count.

Virtual server #1 has a transaction count of 20, and virtual server #1-1 has a transaction count of 60. Virtual server #1-2 has a transaction count of 20, and virtual server #1-4 has a transaction count of 20. Virtual server #1-4 has a transaction count of 100. It is assumed that a scale-out operation is triggered when the average transaction count exceeds a threshold of 100.

In the illustrated case, virtual server #1 sees an average transaction count of 44, meaning that the system of virtual servers as a whole is within the range below the threshold. Virtual server #1-4, however, is executing one hundred transactions, which is as high as the threshold for scale-out operations. As can be seen, the transaction counts are not evenly distributed across virtual servers.

In addition, virtual server #1 is supposed to receive transaction counts from as many virtual servers as the total number of virtual servers in the system minus one. For example, virtual server #1 receives transaction counts from four servers in the example of FIG. 34. If the system grows up to 1,000 virtual servers, virtual server #1 will have 999 subordinate virtual servers and experience an increased communication load for the measurement of transaction counts. This load could hamper the virtual server #1 from timely execution of autoscaling.

As can be seen from the above description, the conventional system is unable to perform autoscaling promptly because of increased communication load. This is because the tasks of collecting transaction counts are concentrated into a single virtual server. It would also be difficult to deal with possible unevenness of transaction counts in virtual servers if one virtual server measures the average transaction count of the entire system.

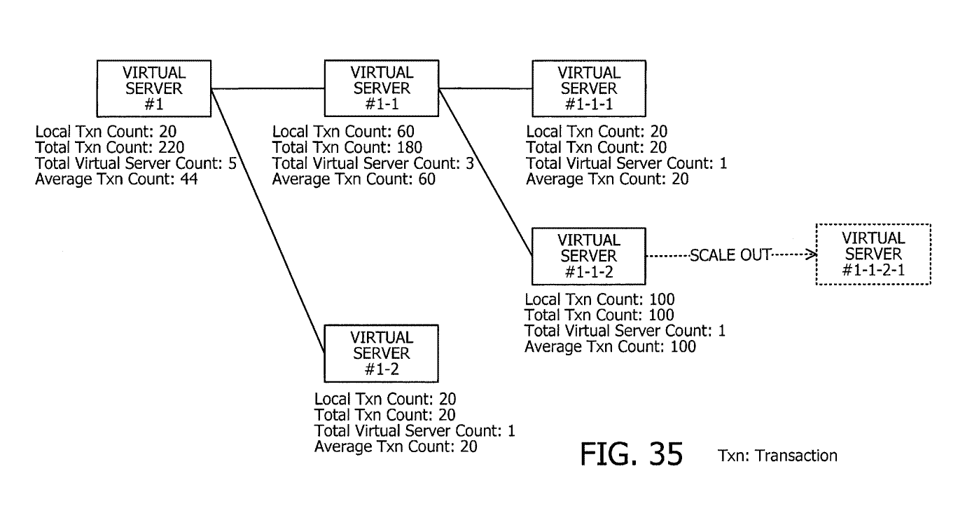

FIG. 35 is a second block diagram for explaining advantages of the second embodiment. This block diagram of FIG. 35 explains management of autoscaling using the method proposed in the second embodiment. The illustrated system includes four virtual servers #1, #1-1, #1-2, #1-1-1, and #1-1-2 used by the execution server 100. These virtual servers #1, #1-1, #1-2, #1-1-1, and #1-1-2 execute transactions in parallel as requested by a terminal device 21 (not illustrated). In FIG. 35, virtual servers #1, #1-1, #1-2, #1-1-1, and #1-1-2 organize a tree structure describe below. That is, virtual server #1 has two child virtual servers #1-1 and #1-2, but no parent virtual servers. Virtual server #1-1 has a parent virtual server #1 and two child virtual servers #1-1-1 and #1-1-2. Virtual server #1-2 has a parent virtual server #1 but no child virtual servers. Virtual servers #1-1-1 and #1-1-2 have their common parent virtual server #1-1, but no child virtual servers.

Virtual server #1 has a local transaction count of 20, and virtual server #1-1 has a local transaction count of 60. Virtual server #1-2 has a local transaction count of 20, and virtual server #1-1-1 has a local transaction count of 20. Virtual server #1-1-2 has a local transaction count of 100. It is assumed that a scale-out operation is triggered when the average transaction count exceeds a threshold of 100.

Referring to virtual server #1-1-1, its total virtual server count is one, and its total transaction count is 20 because of the absence of child virtual servers. The average transaction count of virtual server #1-1-1 is thus calculated to be 20. Referring to virtual server #1-1-2, its total virtual server count is one, and its total transaction count is 100. The average transaction count of virtual server #1-1-2 is thus calculated to be 100.

Virtual server #1-1, on the other hand, has two child virtual servers #1-1-1 and #1-1-2. The total virtual server count of this virtual server #1-1 is three (=1+1+1), and the total transaction counts sum up to 180 (=20+100+60). Accordingly, the average transaction count of virtual server #1-1 is calculated be 60 (=180/3). Referring to virtual server #1-2, its total virtual server count is one, and the total transaction count is 20 because of the absence of child virtual servers. The average transaction count of virtual server #1-2 is thus calculated to be 20.

Referring lastly to virtual server #1, this server has two child virtual servers #1-1 and #1-2. The total virtual server count of virtual server #1 is five (=3+1+1), and the total transaction count is 220 (=180+20+20). Accordingly, the average transaction count of virtual server #1 is calculated be 44 (=220/5).

Virtual server #1 sees its average transaction count, 44, as being smaller than the threshold. In contrast, virtual server #1-1-2 determines to request a scale-out operation because its average transaction count, 100, reaches the threshold.

Each of the virtual servers receives transaction counts from at most two child virtual servers because they are organized in structural tree form as seen in FIG. 35. This fact does not change even if the system swells up to one thousand virtual servers, as long as they are tree structured. The proposed method thus distributes the communication traffic for propagating transaction count information.

As can be seen from the above, the tree structure of virtual servers distributes the load of measurement and communication tasks of transaction counts. Each virtual server keeps track of the average number of transactions executed in itself and its descendants and makes individual scaling decisions, thus equalizing the virtual servers in terms of their transaction counts.

As described previously, the proposed information processing functions of the first embodiment may be provided by executing a program therefor on the servers 10, 10a, 10b, and 10c. The proposed information processing functions of the second embodiment may be provided by executing a program therefor on the execution server 100. These programs may be recorded on a non-transitory computer-readable storage medium (e.g., storage medium 43 in FIG. 3). Suitable storage media may be, for example, magnetic disks, optical discs, magneto-optical discs, and semiconductor memory devices. Magnetic disks include FD and HDD. Optical discs include CD, CD-Recordable (CD-R), CD-Rewritable (CD-RW), DVD, DVD-Recordable (DVD-R), and DVD-Rewritable (DVD-RW).

For the purpose of distribution of programs, portable storage media containing those programs may be provided. It is also possible to store programs in a storage device of some other computer as downloadable code for distribution via a network 31. For example, a computer reads out programs from a portable storage medium or receives programs from another computer. The computer installs those programs into its local storage device (e.g., HDD 103) and executes stored programs after reading them out of the storage device. The computer may also execute programs while reading them out of a portable storage medium or receiving them from another computer via the network 31, without installing them into local storage devices. It is noted that the above-described information processing functions may wholly or partly be implemented with a DSP, ASIC, programmable logic device (PLD), or other electronic circuits.

Two embodiments and their variants have been discussed above. In one aspect of the embodiments, the proposed techniques make it possible to quickly determine whether to enhance the system.

All examples and conditional language provided herein are intended for the pedagogical purposes of aiding the reader in understanding the invention and the concepts is contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a program that causes a computer to perform a procedure comprising:
receiving, as a first server, a load value from at least one second server, the first and second servers being among a plurality of servers provided by executing server software on the computer or other computers in a system, the plurality of servers having subordinate relationships for propagating load values from one server to another server in the system, the second server being subordinate to the first server, the received load value representing a load on a group of servers including the second server and subordinate servers thereof; and
determining, as the first server, whether to enhance the system, based on a load value of the first server and the load value received from the second server.

2. The non-transitory computer-readable storage medium according to claim 1, wherein the procedure further comprises:
issuing a request for adding to the system a server subordinate to the first server, when the determining has determined to enhance the system.

3. The non-transitory computer-readable storage medium according to claim 1, wherein the determining includes:
determining to enhance the system when an average load value of the first server and the group of servers is equal to or greater than a threshold.

4. The non-transitory computer-readable storage medium according to claim 1, wherein the determining includes:
determining to shrink the system when an average load value of the first server and the group of servers is smaller than a threshold.

5. The non-transitory computer-readable storage medium according to claim 4, wherein the procedure further comprises:
issuing a request for stopping the first server when the determining has determined to shrink the system.

6. The non-transitory computer-readable storage medium according to claim 1, wherein the determining includes:
determining to enhance the system when an average load value of the first server and the group of servers exhibits a variation that is equal to or greater than a threshold.

7. The non-transitory computer-readable storage medium according to claim 1, wherein the determining includes:
determining to shrink the system when an average load value of the first server and the group of servers exhibits a variation that falls below a threshold.

8. The non-transitory computer-readable storage medium according to claim 1, wherein the first server is implemented as a virtual machine constructed by the computer, and the virtual machine is configured to perform the receiving and the determining.

9. The non-transitory computer-readable storage medium according to claim 8, wherein:
a plurality of virtual machines are constructed by the computer so as to cause each of the virtual machines to work as a server; and
each of the servers implemented on the virtual machines is configured to work as the first server to perform the receiving and the determining.

10. The non-transitory computer-readable storage medium according to claim 1, wherein the plurality of servers are organized in a tree structure for propagating load values from one server to another server.

11. A management method comprising:
receiving, by a first server, a load value from at least one second server, the first and second servers being among a plurality of servers provided by executing server software on computers in a system, the plurality of servers having subordinate relationships for propagating load values from one server to another server in the system, the second server being subordinate to the first server, the received load value representing a load on a group of servers including the second server and subordinate servers thereof; and
determining, by a computer as the first server, whether to enhance the system, based on a load value of the first server and the load value received from the second server.

12. A computer comprising
a processor configured to perform a procedure including:
receiving, as a first server, a load value from at least one second server, the first and second servers being among a plurality of servers provided by executing server software on the computer or other computers in a system, the plurality of servers having subordinate relationships for propagating load values from one server to another server in the system, the second server being subordinate to the first server, the received load value representing a load on a group of servers including the second server and subordinate servers thereof; and
determining, as the first server, whether to enhance the system, based on a load value of the first server and the load value received from the second server.
